(19) United States
(12) Patent Application Publication
(10) Pub. No.: US 2016/0056510 A1
(43) Pub. Date: Feb. 25, 2016

(54) ASSEMBLED BATTERY SYSTEM, STORAGE BATTERY SYSTEM, AND METHOD FOR MONITORING AND CONTROLLING ASSEMBLED BATTERY SYSTEM

(71) Applicant: HITACHI, LTD., Tokyo (JP)

(72) Inventors: Takashi TAKEUCHI, Tokyo (JP); Takahide TERADA, Tokyo (JP); Masayuki MIYAZAKI, Tokyo (JP)

(73) Assignee: HITACHI, LTD., Tokyo (JP)

(21) Appl. No.: 14/655,428

(22) PCT Filed: Dec. 28, 2012
(86) PCT No.: PCT/JP2012/084057

§ 371 Date: Oct. 5, 2015

(51) Int. Cl. H01M 10/48; H01M 10/42

(52) U.S. Cl. CPC H01M 10/482; H01M 10/425; H01M 2010/4271; H01M 2010/4278

(57) ABSTRACT

An assembled battery system includes: a control unit having a cell monitoring unit for obtaining battery information by monitoring the battery state of each secondary battery belonging to a storage battery module and a wireless communication unit for, inside a metal chassis housing the storage battery module, wirelessly transmitting the battery information; and a management device for, inside the metal chassis, wirelessly communicating with and managing each of the storage battery modules. The management device transmits to each of the storage battery modules a measurement instruction including information specifying the next measurement timing at predetermined intervals and controls the cell monitoring unit to measure, according to the measurement instruction, the battery states of the storage batteries concurrently among a storage battery modules.

### TECHNICAL FIELD

The present invention relates to an assembled battery system, a storage battery system, and a method for monitoring and controlling the assembled battery system.

### BACKGROUND ART

Secondary batteries such as lead batteries, lithium ion batteries, etc. are widely used in various fields in a driving system for land, sea, and air vehicles (ships, rail way cars, automobiles, etc.), UPSs (Uninterruptible Power Supply) for backup, and large-scale storage battery installations for stabilization of power transmission systems. In these storage battery installations, a storage battery system is configured to obtain an output power and a capacity demanded for the system by connecting a lot of secondary cells and/or secondary battery modules in series, and parallel. In the secondary battery, a current and a power quantity capable of being charged and discharged are predetermined on the basis of their chemical characteristics. When the secondary battery is used exceeding the predetermined current and a predetermined power quantity of miniature capable of being charged and discharged, a rapid deterioration or a failure may be caused. To prevent this, it is necessary to perform charging and discharging while the state of the secondary battery is monitored. Because a current flowing into the storage battery system varies every moment, in a storage battery module in which it is assumed that a large current variation occurs in a particularly short interval, it is required to collect battery information in a short period.

Further it is necessary to measure states of battery modules at the same time at a high time accuracy to minimize measurement errors in the state information of a voltage, a current, a temperature, a capacity, etc. of each storage battery modules forming a battery system.

In prior art assembled battery systems, storage battery modules are installed in a metal housing, being incombustible, and a battery controller monitors a state of each of the storage battery modules. The battery controller is connected to each of the storage battery modules to collect information such as a voltage periodically. However, it is proposed to make the communication wireless because of high costs for insulation due to a lot of wirings and maintenance (periodical inspection).

Patent document 1 discloses an assembled battery system configured including a plurality of battery cells connected in series in which battery information of the battery cells is transmitted to managing device using a wireless communication signal.

### PRIOR ART PATENT DOCUMENT

PATENT DOCUMENT1: JP2010-142083A

### SUMMARY OF INVENTION

### Problem to be Solved by Invention

However, in the assembled battery system in which an antenna for wireless communication is installed inside the metal housing as disclosed in PATENT DOCUMENT1, a transmission path between antennas has a multipath environment because a lot of reflection waves are generated due to reflection of electromagnetic waves inside the metal housing. Accordingly, at a receiving point of an antenna, a plurality of magnetic waves are combined, so that the transmission characteristic varies depending on a position of the antenna and a communication frequency. For example, there may be a case where a propagation characteristic of electromagnetic wave in a communication channel is good, and on the other communication channel, the propagation characteristics of electromagnetic wave may largely decrease. Because the propagation characteristics of electromagnetic waves largely vary depending on the frequency, it becomes impossible to communicate between the managing device side and the storage battery modules at a frequency. In this case, there is a problem in that a measuring command is not transmitted to a storage battery module having a deteriorated propagation characteristics of electromagnetic waves at the corresponding frequency.

On the other hand, in a case where sealing of electromagnetic waves by the metal housing is not perfect due to heat discharging, etc. of the assembled battery system, there is a problem in that communication between assembled battery systems adjoining each other interfere communications therebetween in a storage battery system including a plurality of assembled battery systems which are used by connecting in series or parallel. Further, when there is leak of magnetic waves from the assembled battery system, a method of avoiding interference with an adjoining system without decrease in the magnetic wave propagation inside the metal housing because a propagation characteristic inside the housing depending on its peripheral environment will vary even if a propagation characteristics adjustment is performed in advance.

The present invention aims to provide an assembled battery system, a storage battery system, which provides appropriate communications, and a method of monitoring and controlling the assembled battery system and the storage battery system.

### Means for Solving Problem

To solve the problem, there is a provided an assembled battery system comprising:

a storage battery module side managing device including:

a battery monitoring unit monitoring a battery state of each of storage batteries to which a storage battery module including a plurality of storage batteries connected in series, parallel, or serial-parallel belong and acquiring the battery information; and

a storage battery module side managing device including a communication unit performing wireless transmission of the battery information inside a metal case housing the storage battery modules;

a managing device that manage the respective storage battery modules by performing wireless communication in the metal case each other with each of the storage battery module side managing devices equipped with each of the storage battery modules, wherein the managing device transmits a measuring command including information specifying a next measuring timing to the respective storage battery module side managing devices to control in accordance with the measuring command the battery monitoring units to measure the battery states instantaneously between respective storage battery modules.

The storage battery system according to the present invention features that in the storage battery system including a plurality of the assembled battery systems which are arranged, one of a communication time, a communication frequency, a communication space, and a spreading code is changed for each assembled battery system.

### Advantageous Effect of Invention

According to the present invention, the assembled battery system, and the storage battery system, which provide appropriate communication, and a method of monitoring and controlling the assembled battery system and the storage battery system can be provided.

### BRIEF DESCRIPTION OF DRAWINGS

FIG. 1 is a drawing illustrating configuration of a storage battery system including a plurality of assembled battery systems arranged in parallel according to a first embodiment.

FIG. 2 illustrates a configuration of an assembled battery system according to the first embodiment.

FIG. 3 illustrates a configuration of storage battery modules according to the first embodiment.

FIG. 4 illustrates a configuration of the assembled battery system including storage battery modules according to the first embodiment.

FIG. 5 illustrates a relationship between battery characteristics and battery information collecting period of the assembled battery system according to the first embodiment.

FIGS. 6A and 6B are drawings illustrating propagation characteristics of electromagnetic waves inside a small case having storage battery modules according to the first embodiment.

FIGS. 7A to 7C are drawings illustrating the propagation characteristic of electromagnetic waves inside the assembled battery system according to the first embodiment.

FIG. 8 is a drawing illustrating interference due to magnetic wave leakage between assembled battery systems according to the first embodiment.

FIG. 9 is a drawing schematically illustrating in a case where a plurality of the assembled battery systems according to the first embodiment, which are arranged.

FIG. 10 is a drawing illustrating a method of avoiding interference by a multiple access control method of the assembled battery system according to the first embodiment.

FIG. 11 is a flowchart illustrating communication control of a managing device for the assembled battery system according to a second embodiment of the present invention.

FIGS. 12A to 12E are control sequence drawings illustrating communication control between the managing device of the assembled battery system and each of the storage battery modules according to the second embodiment.

FIG. 13 is a drawing illustrating an example of time division multiple access between the managing device and the storage battery module in the assembled battery system according to the second embodiment.

FIG. 14 is a flowchart illustrating communication control for a managing device of an assembled battery system according to a third embodiment of the present invention.

FIGS. 15A to 15E are control sequence drawings illustrating communication control between the managing device for the assembled battery system and each of the storage battery modules according to the third embodiment.

FIG. 16 is a drawing illustrating an example of performing time division multiple access between the managing device and the storage battery module inside the assembled battery system according to the third embodiment.

FIG. 17 is a drawing illustrating an example in which the time division multiple access is performed between a managing device and a storage battery module of an assembled battery system according to a fourth embodiment of the present invention.

FIG. 18 is a drawing illustrating an example in which the time division multiple access is performed between a managing device and a storage battery module of an assembled battery system according to a fifth embodiment of the present invention.

FIG. 19 is a drawing illustrating an example in which the time division multiple access is performed between a managing device and a storage battery module of an assembled battery system according to a sixth embodiment of the present invention.

FIG. 20 is a drawing illustrating an example in which the time division multiple access is performed between a managing device and a storage battery module of an assembled battery system according to a seventh embodiment of the present invention.

FIGS. 21A to 21G are control sequence drawings illustrating a communication control between the managing device 120 and each of the storage battery modules according to an eighth embodiment.

FIGS. 22A to 22G are control sequence drawings illustrating a communication control between the managing device and each of the storage battery modules according to the eighth embodiment.

### MODES FOR CARRYING OUT INVENTION

Hereinbelow embodiments of the present invention are described in detail with reference to drawings.

### First Embodiment

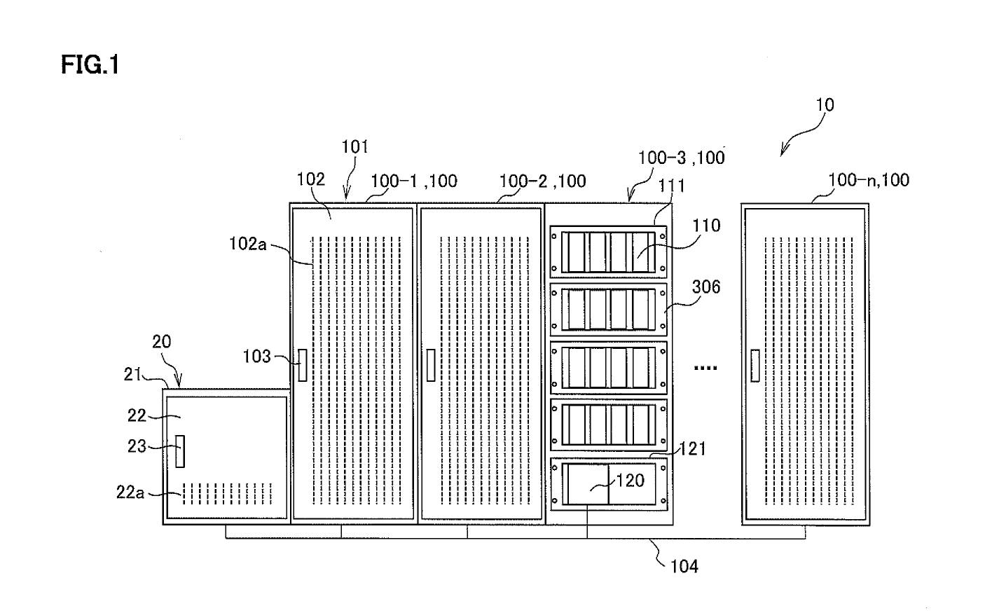

FIG. 1 is a drawing illustrating configuration of a storage battery system including a plurality of arranged assembled battery systems according to a first embodiment. The storage battery system according to the embodiment is an example in which the present invention is applied to an assembled battery system in which monitoring and controlling a plurality of battery cells is performed using a wireless signal.

### [Whole Configuration]

As shown in FIG. 1, a storage battery system 10 is configured including a plurality of arranged assembled battery systems 100-1 to 100-n; and a storage battery system controller 20 for managing a whole of the assembled battery systems 100-1 to 100-n. Because the assembled battery systems 100-1 to 100-n have the same configuration, the assembled battery system 100-3 is reprehensively shown. Further, in a case where the assembled battery systems 100-1 to 100-n are not specifically distinguished from each other, they are described as the assembled battery system 100.

The assembled battery system 100 includes a plurality of storage battery modules 110 arranged in an aligned manner (to have four tiers each including four battery modules) and a managing device 120.

The assembled battery system 100 is housed in a battery rack including a metal housing 101. Provided on a front face of the metal housing 101 are a door 102, a handle 103 for opening and closing the door 102 to have such a configuration as to inspect the storage battery module 110 thereinside as necessary. The door 102 has mesh holes 102a to take the air thereinto for cooling inside the metal housing. It is assumed that the holes 102a have a longitudinal side which is shorter than a half of a wavelength of the microwave of the wireless communication inside the metal housing 101. The metal housing 101 forms a case of one of assembled battery systems 100. The managing device 120 is also housed in a metal housing 21 which has a metal door 22 on the front face of the metal housing 21 and a handle 33 for opening and closing the metal door 22. The metal door 22 has mesh holes 22a.

The assembled battery system 100 provides a preferable communication quality because the assembled battery system 100 is covered with the metal housing 101, which prevents the wireless communication signal from leaking outside, so that the system does not receive interference of wireless communication signals from outer other systems. Further, conductors forming the metal housing 101 may have meshes having grids with a sufficiently smaller than a wavelength.

As shown in FIG. 1, a plurality of layers are fixed to the metal housing 101, the layers including a plurality of small cases 111 each housing the storage battery modules 110, and a small case 121 housing the managing device 120. The metal housing 101 forms a battery rack and one battery rack corresponds to one assembled battery system 100. In FIG. 1, the assembled battery system 100-1 to 100-n and the storage battery system controller 20 form the storage battery system 10. Further, four storage battery modules 110 are housed inside the metal housing 101 and the managing device 120 is installed at a lower inner part of the metal housing 101. An outer electrode interface 104 for outputting is provided at a lower part of the metal housing 101.

Information of each of the storage battery module collected by the managing device 120 inside the assembled battery system 100 is transmitted from the managing device 120 to the storage battery system controller 20 as an upper controller for each of the assembled battery systems 100-1 to 100-n through the outer electrode interface 104, so that the storage battery system controller 20 can manage the whole of the assembled battery system 100.

When a plurality of the assembled battery systems 100 for performing wireless communication inside the metal housing 101 are arranged to form the storage battery system 10, it is necessary to avoid interference between wireless communication electromagnetic waves of the assembled battery system 100.

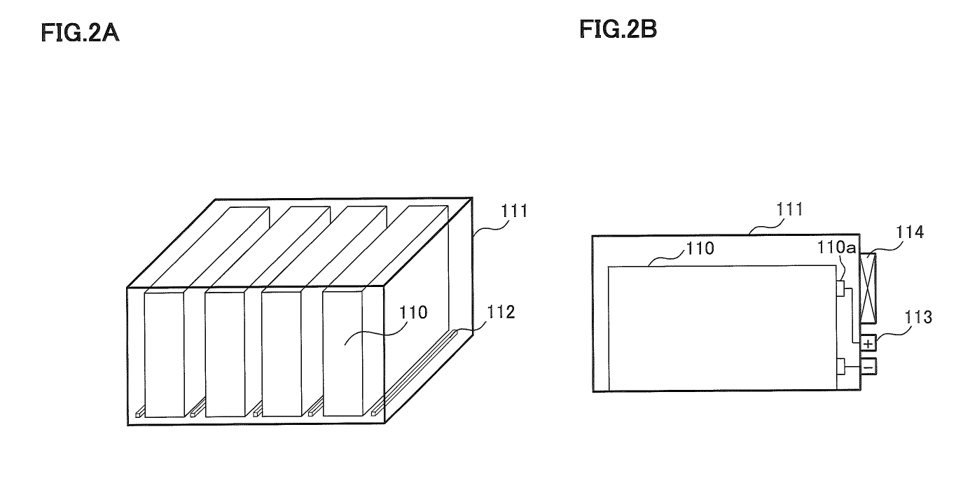

FIGS. 2A and 2B illustrate configuration of the assembled battery system 100, in which FIG. 2A is a perspective view illustrating the inside of the assembled battery system 100 transparently, and FIG. 1B is a side view thereof.

As illustrated in FIGS. 2A and 2B, each of the storage battery modules 110 are fixed in the metal small case 111 in such a state that guides 112 provide gaps for cooling and insulation. The small case 111 arranges each of the storage battery modules 110 and includes an electrode terminal 113 and a cooling fan 114 on a back face thereof. An electrode terminal 110a of the storage battery module 110 corresponds 1:1 to the electrode terminal 113 on a back face of the small case 111. Serial and parallel connection configuration of each of the storage battery modules 110 can be changed by changing a connection method of the electrode terminals 113. In addition, the air-cooling fan 114 is provided to heat dissipation. Regarding this, the metal case has a good heat conduction rate to easily control a temperature of the battery and has such an advantageous characteristic as to reflect and shield magnetic waves.

The arrangement, the number of devices, and shapes of the storage battery modules 110, the small case 111, and the assembled battery systems 100-1 to 100-n, etc are examples and any other configuration may be used.

### [Inside Configuration of the Assembled Battery System]

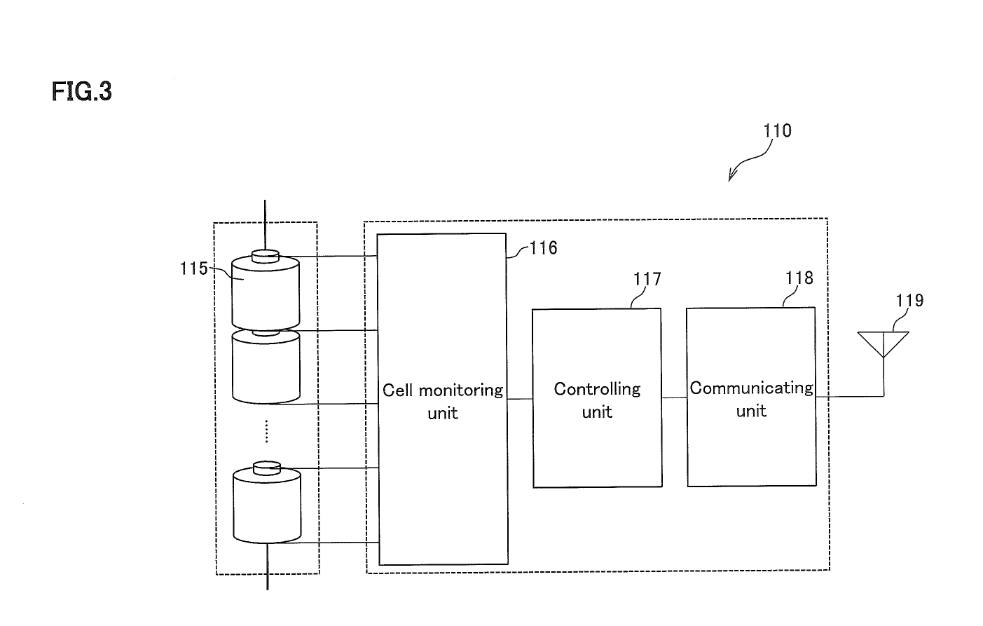

FIG. 3 illustrates configuration of the storage battery module 110 described above.

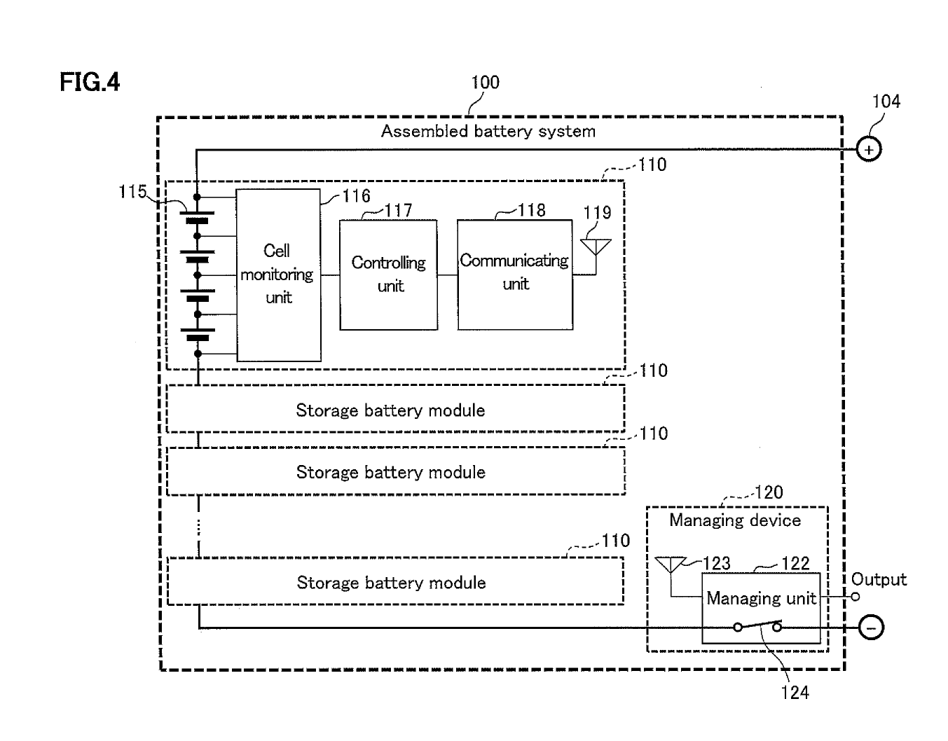

FIG. 4 illustrates a configuration of the assembled battery system 100 including each of the storage battery modules 110 described above.

### [Storage Battery Module 110]

As illustrated in FIGS. 3 and 4, the storage battery module 110 includes secondary batteries 115 connected in series, a cell monitoring unit 116, a controlling unit 117, a communicating unit 118, and an antenna 119. In FIGS. 3 and 4, the cell monitoring unit 116 (battery monitoring unit), the controlling unit 117, the communicating unit 118, and the antenna 119 are connected to the secondary batteries 115 to provide one storage battery module 110.

The secondary battery 115 includes a plurality of battery cells having a serial connection, a parallel connection and a serial-parallel connection. Further, an electrode at a highest potential and an electrode at a lowest potential are outputted as the outer electrode interface 104 (see FIG. 4). Regarding this, the outer electrode interface 104 includes a switch 124 (see FIG. 4) which turns on only in a predetermined condition to prevent the outer electrode interface 104 from erroneously outputting a high voltage or a large current because the outer electrode interface 104 can apply a high voltage or a large current. Further, when outputting is made outside the metal housing 101, making a gap between the metal housing 101 and the outer electrode interface 104 sufficiently smaller than the wavelength used for the wireless communication, prevents the wireless signal from leaking outside or receiving interference from communication signals from outer other system.

The cell monitoring unit 116 monitors a battery state of each batteries belonging to the battery module including a plurality of batteries connected in series, parallel, or serial-parallel to acquire battery information. The cell monitoring unit 116 sends measurement values of cell information in response to demand from the controlling unit 117. The cell monitoring units 116 has modes, in one of the modes measurement is always made and in the other modes, the measurement is started only when there is a demand from the cell monitoring unit 116.

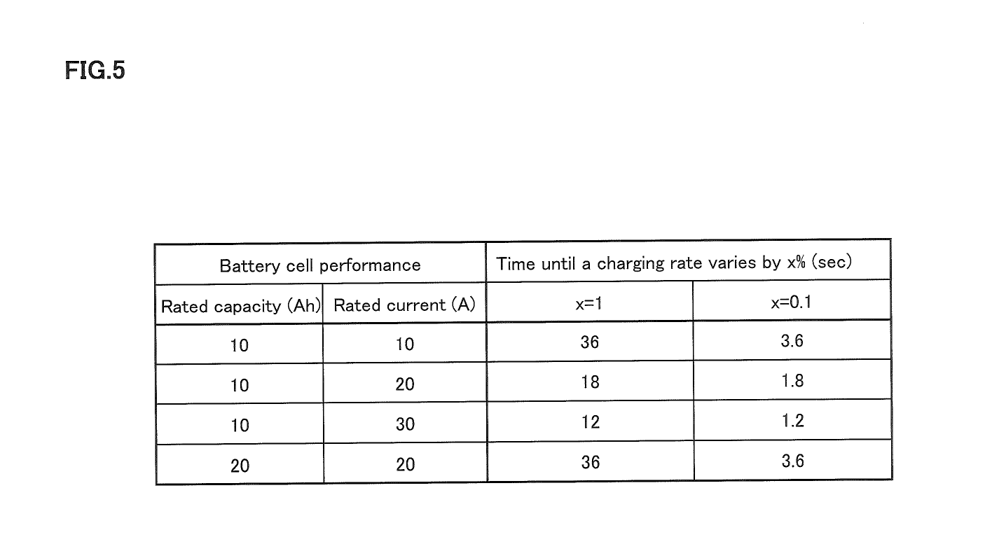

The controlling unit 117 includes a microcontroller and a storing unit (not shown) for storing battery information, a measuring command (monitoring and controlling command), and a wireless communication mode. The controlling unit 117 has a function as a battery module side managing device which measures battery states of the secondary batteries 115 between each of the battery modules 110 in response to a measuring command from a managing device 120, simultaneously. The controlling unit 117 commands the cell monitoring unit 116 on the basis of the measuring command (monitoring control command) received from the managing device 120 and acquires the battery information (battery information) from the cell monitoring unit 116. Further, the controlling unit 117 performs communication control regarding the measuring command with the managing device 120 using a communicating unit 118. Incidentally, a collecting period of the battery information there is a restriction in time. More specifically, because a current flowing into the assembled battery system varies from moment to moment, it is required to collect the battery information simultaneously at the same battery information acquiring timing at a short period between the storage battery modules 110. The battery information collecting period is described later with reference to FIG. 5.

The wireless communicating unit 118 includes a wireless communication circuit etc. for transmitting the battery information wirelessly inside the metal housing 101 housing the corresponding battery modules. For example, the communicating unit 118 uses a short range low power bidirectional wireless communication method such as ZigBee (registered trademark), Bluetooth (registered trademark), UWB (Ultra Wideband). Further, a wireless LAN (WLAN: Wireless Local Area Network) based on the standard of IEEE802.11x) is also usable. Further, either of TDMA (Time Division Multiple Access)/FDMA (Frequency Division Multiple Access)/CDMA (Code Division Multiple Access) is usable as a wireless multiple access method. In this embodiment, the wireless communication is performed by time division between the storage battery modules 110, by frequency division between the assembled battery systems 100, by code division between the storage battery system 10 with other storage battery system 10. The communicating unit 118 wirelessly transmits the battery information to the managing device 120 and receives the measuring command (monitoring and controlling command) from the managing device 120. As a transmission method of wirelessly transmitting data, there is a data transmitting method in which transmission is made at predetermined timings with reference to a synchronizing signal from the managing device 120 and a data transmission method returning a response in response to the command from the managing device 120.

The antenna 119 may be a rod, a coil, or a plate, or a conductor pattern on a print circuit board.

### [Managing Device 120]

The managing device 120 (see FIG. 4) performs wireless communication with the controlling unit 117 as a storage battery module 110 side device inside the metal housing 101 each other to manage the respective storage battery modules. The managing device 120 transmits the measuring command including information indicating the next measuring timing to each of the controlling units 117 (battery module side managing devices) at a predetermined interval to control the cell monitoring units 116 to measure the battery states simultaneously among the storage battery modules 110 in accordance with the measuring command.

The managing device 120 includes a managing unit 122 and an antenna 123. The managing unit 122 includes a control unit and a communicating unit (not shown) like the controlling unit 117 and the communicating unit 118, of the storage battery module 110. However, the control program is different from that for the control unit of the managing unit 122. Respective storage battery modules 110 and the managing device 120 are housed inside the metal housing 101 (see FIG. 1) to form one assembled battery system 100.

The storage battery module 110 performs communication with the managing device 120 through the antennas 119, 123 to transmit the battery information. The managing unit 122 can cut off the power supply line by the switch 124 when an error is detected.

The managing device 120 periodically transmits the measuring command including information specifying the next measuring time to each of the storage battery modules 110. The managing device 120 can secure withstand voltages by acquiring the battery information of the secondary batteries 115 wirelessly, so that the battery information can be easily collected.

The managing device 120 collects the battery information of each of the storage battery modules 110 and monitors and controls each of the storage battery modules 110 to perform a desired function as the assembled battery system 100. More specifically, the managing device 120 collects information such as a cell voltage and a temperature, etc. of each of the secondary batteries 115 and monitors whether the secondary batteries 115 are used at appropriate voltages and temperatures. Further, the managing device 120 makes such a control as to make dissipation in the remaining charge amount (cell voltage) of the secondary batteries 115 small. These monitoring controls are performed on the basis of the information provided by a demand from an outer system or information supplied from outer systems periodically or when the condition agrees with a specific condition. The battery information is information regarding, for example, a cell voltage or a temperature, an internal resistance value, a remaining charge amount, a discharging state, ID, presence/absence of an error, a deterioration degree, etc, of the secondary battery 115,

### [Collecting Period of Battery Information]

FIG. 5 illustrates a relationship between a battery cell performance and battery information collecting periods of the assembled battery system according to the first embodiment.

The battery information collecting period varies in accordance with a rated current, a rated capacity of a battery cell, and a detection accuracy of an SOC necessary for the system (State Of Charge).

As shown in FIG. 5, when the SOC of the secondary battery 115 having, for example, a capacity of 10 Ah and an output current of 20 A, is detected at an accuracy of 0.1%, it is necessary to collect the battery information from all the storage battery modules 110 within 1.8 sec.

As described above, the assembled battery system is different from other general wireless communication systems in having a timewise restriction in the battery information collecting period.

Hereinbelow, an operation of the assembled battery system 100 configured as described above is described.

First a basic way of thinking the present invention is described.

### [Propagation Characteristic of Electromagnetic Waves Inside Assembled Battery System]

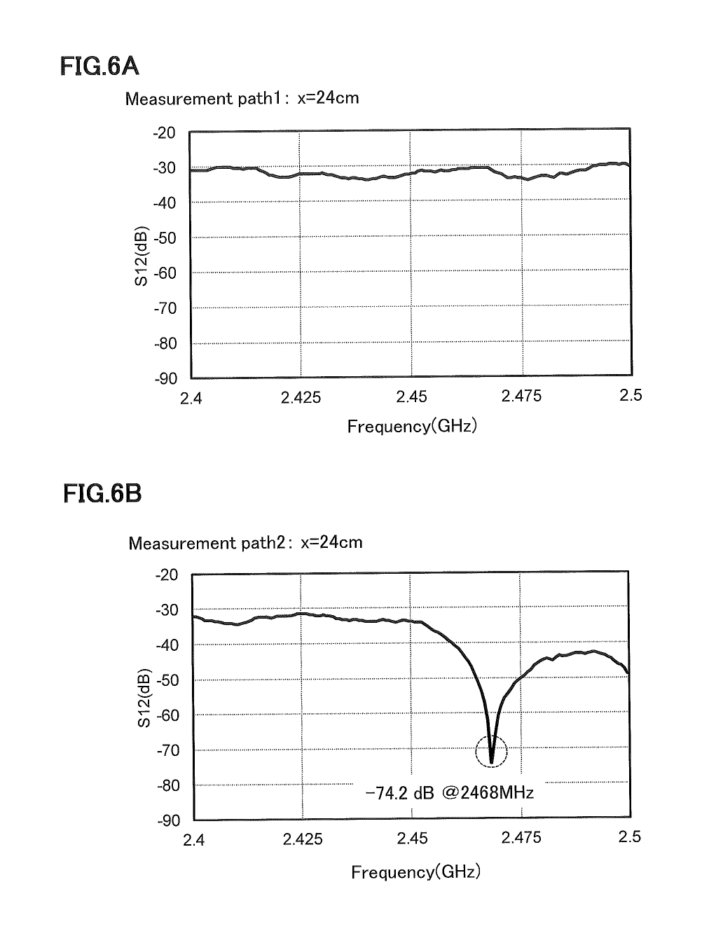

FIGS. 6A and 6B are drawings illustrating a propagation characteristic of electromagnetic waves inside each of paths in a small case 111 housing the storage battery modules 110 as shown in FIG. 2A when a wireless communication frequency is changed from 2.4 GHz to 2.5 GHz. FIGS. 6A and 6B illustrate propagation characteristics of electromagnetic waves, extracted at positions having a depth x=24 cm of the storage battery modules 110 between the adjoining modules 110.

Further, a band of 2.4 GHz is a usable frequency band for ZigBee (registered trademark) and Bluetooth (registered trademark).

On the measuring path 1 shown on FIG. 6A, the propagation characteristic of electromagnetic waves is preferable. However, as shown in FIG. 6B, inside the small case 111 or the battery rack (metal housing 101: assembled battery system 100), multi-path reception occurs due to reflection of the electromagnetic waves, so that the propagation characteristic of electromagnetic waves has falling in accordance with a position and a frequency. In this example, the propagation characteristic of electromagnetic wave largely falls at 2.468 GHz by −74.2 dB. If it is assumed that there is a communication channel allocated to this frequency band, there occurs a problem in a transmission error of the measuring command to the storage battery modules using the corresponding communication channel. As described above, since the propagation characteristic of electromagnetic waves largely depends on the frequency, communication between the managing device 120 side and the storage battery module 110 cannot be performed at a certain frequency.

### [Electromagnetic Wave Leakage to Outside of Assembled Battery System]

In addition to deterioration in the propagation characteristic of electromagnetic waves due to the multi-path inside the assembled battery system, there is a problem in occurrence of interference when the battery racks (the assembled battery systems 100) are arranged. According to experiments by the inventors of the present invention, when electromagnetic wave leakage is measured when the battery racks are arranged, attenuation due to the battery rack is about 5 dB/rack. Accordingly, there is a large electromagnetic wave leakage. However, the battery rack used for evaluation, being not optimized for wireless communication, has slits for cables and holes for ventilation.

Detailed explanation about the deterioration in the propagation characteristics of electromagnetic waves inside the assembled battery system described above and the interference due to electromagnetic wave leakage between the assembled battery systems.

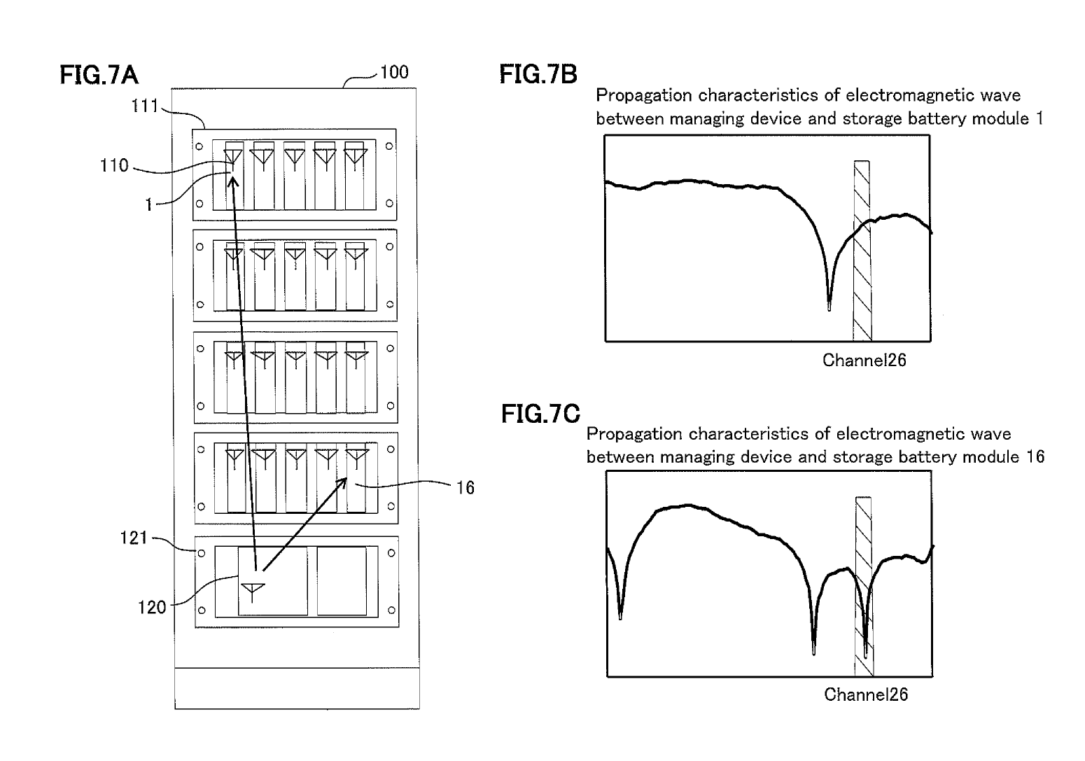

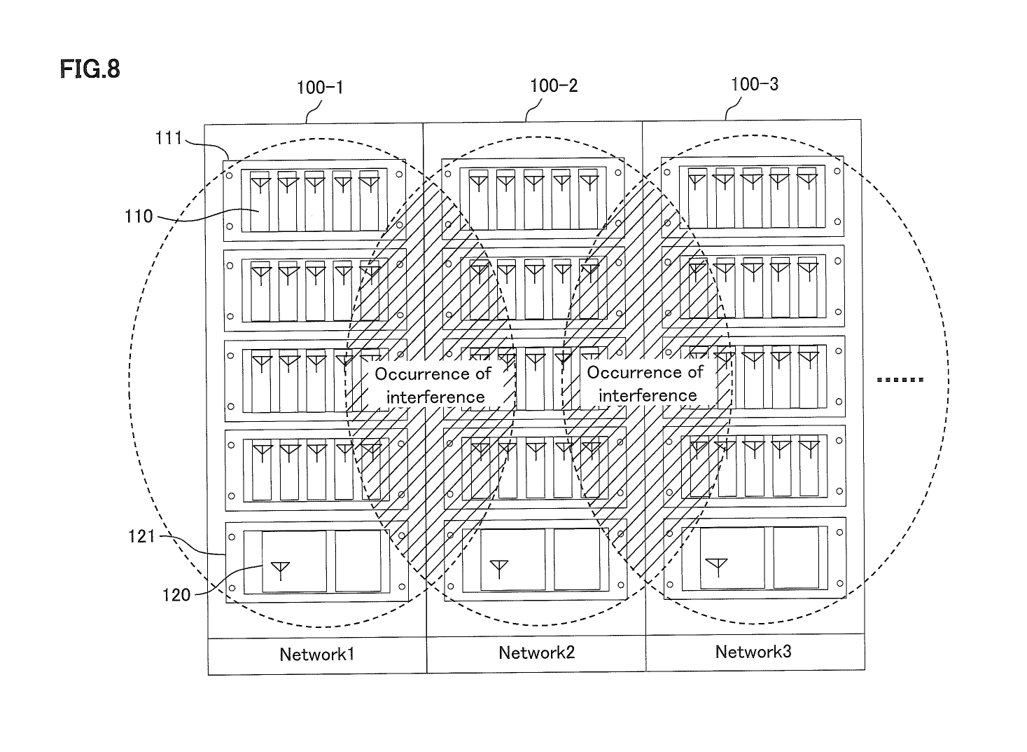

FIGS. 7A to 7C are views illustrating the propagation characteristics of electromagnetic waves inside the assembled battery system in which FIG. 7A is a structural drawing of the assembled battery system indicating a positional relation between each of the storage battery modules 110 and the managing device 120, FIG. 7B illustrates a propagation characteristic of electromagnetic waves between the managing device 120 and storage battery module 1, and FIG. 7C illustrates a propagation characteristic of electromagnetic waves between the managing device 120 and the storage battery module 16, respectively. In FIGS. 7A and 8, the assembled battery system 100 is shown as an example in which four layers each including five storage modules 110. In addition, it is assumed that the number of channels, being able to be broadcasted to the storage battery module 110, is “26”.

In the case of the assembled battery system shown in FIG. 7A, the propagation characteristic of electromagnetic waves between the managing device 120 and a storage battery module 1 is shown in FIG. 7B, and the propagation characteristic of electromagnetic waves between the managing device 120 and a storage battery module 16 is shown in FIG. 7C. When the managing device 120 performs transmission to all the storage battery modules at the same frequency, communication to the storage battery module 1 is successfully performed, on the other hand, communication to the storage battery module 16 is unsuccessfully performed due to deterioration in the propagation characteristics of electromagnetic wave. More specifically, the propagation characteristic of electromagnetic waves varies for each of the storage battery modules 110. Accordingly, there may be no channel capable of broadcasting among all the assembled battery systems 100. Further, due to the falling in the propagation characteristic of electromagnetic waves, a reliability of unicast communication to each of the storage battery modules 110 also decreases. As described above, a reliability of broadcast/unicast of the assembled battery system is assumed to be low.

Particularly, to simultaneously measure a state of each of the storage battery modules 110 when the managing device 120 performs the broadcast to transmit the measuring command to all the storage battery modules simultaneously at a certain frequency, a problem may occur in that the measuring command cannot be transmitted to the storage battery module having deterioration in the propagation characteristic of electromagnetic waves at the corresponding frequency.

FIG. 8 illustrates interference due to electromagnetic wave leakage between the assembled battery systems. Networks 1 to 3 are configured by arranging a plurality of the assembled battery systems 100 shown in FIG. 7A as a battery rack1 (assembled battery system 100-1), a battery rack2 (assembled battery system 100-2), and a battery rack3 (assembled battery system 100-3). Broken lines in FIG. 8 schematically indicate wireless electromagnetic wave regions of respective battery racks.

As shown in FIG. 8, when a plurality of the battery racks are arranged and wireless communication is performed, interference may occur between the battery racks. Particularly, when the frequency is independently selected for each of the networks, interference may occur with adjacent network. Further there may be a problem in that communications between adjacent assembled battery systems 100 may interfere each other if sealing of electromagnetic waves by the metal housing 101 (see FIG. 1) is imperfect due to heat radiation, etc. In addition, in the presence of the electromagnetic wave leakage from the assembled battery systems 100, a propagation characteristic of electromagnetic waves inside the case is changed by peripheral environment (for example, a person passes beside the assembled battery system 100) even though the propagation characteristic of electromagnetic wave inside the case is previously adjusted.

First, related art (1) to (3) using wireless terminals to avoid interference between the networks described above is described and problems occurring when the related art is applied to the assembled battery system is considered.

### (1) CSMA/CA (Carrier Sense Multiple Access/Collision Avoidance)

The CSMA/CA is a technology to avoid interference with other system by sensing a state of a communication path before the wireless terminal transmits. However, since the wireless terminals unable to perform the communication increase as increase in interference, a trouble of delay may increase. Accordingly, there may be a problem in increase in delaying. In the assembled battery system, it is difficult to adopt the CSMA/CA which may increase delay due to temporal restriction in the battery information collecting period.

### (2) The Reliability is Increased by Repeatedly Transmitting Information.

The assembled battery system may have a possibility in that a communication error occur successively around a deep falling of propagation characteristic, because the propagation characteristic of electromagnetic waves does not change though time passes, which is different from the case of a mobile objects, etc.

### (3) Frequency Hopping:

When the assembled battery system is subjected to simply hopping, as described regarding FIG. 8, interference may occur with other battery system.

In consideration of the features of the assembled battery system, the inventors of the present invention reached such an idea that the managing device periodically transmits the measuring command including information for specifying a next measuring time to the storage battery module. The storage battery module performs measurement of the state of the storage battery in accordance with the measuring time information. More specifically, there are following basic approaches (A) to (C) of the present invention.

(A) Different Communicating Method is Used for Each of the Layers of the Assembled Battery System.

The storage battery system according to the present invention has a hierarchical structure including a plurality of storage battery modules, an assembled battery system including a plurality of the storage battery modules, which are grouped in this order. Regarding wireless communication between layers, either of the multiple access control methods of: the time-division method, the frequency division method, or the spread code method is used. Further, regarding the communication for the storage battery systems, different methods are used from TDMA/FDMA/CDMA. For example, the communication between the storage battery modules uses the time division method, the communication between the assembled battery systems uses the frequency division, and the communication between the storage battery systems uses the spread code method, which are switchably used.

(B) the Managing Device Transmits the Measuring Command by the Broadcast.

The managing device transmits the measuring command to each of the storage battery modules by the broadcast and unicast upon re-transmission. The storage battery module transmits the measured battery information to the managing device individually. Further, the managing device transmits the measuring command by broadcasting and, at re-transmission, transmits the measuring command by multihop. In addition, when a field intensity upon communicating in the assembled battery systems is determined to be weak, the communication is performed after change the frequency to one of previously allocated frequencies.

(C) in a Case of Re-Transmission, the Wireless Communication is Performed Via Another Storage Battery Module.

When the managing device cannot receive a response from the storage battery module, the managing device selects a predetermined storage battery module as a relay device from the storage modules whose responses were able to be received and causes the storage battery module to relay the measuring command and the response of the battery information. Regarding this, the managing device may select one of the storage battery modules having a battery with a high SOC and causes the storage battery module to perform relaying. Further, when the managing device fails to perform communication though the frequency has been changed, or when there is only one allocated frequency, the managing device causes the storage battery module which were able to receive the response to perform relaying.

An operation of the storage battery system 10 in which a plurality of the assembled battery systems are arranged is described below on the basis of the basic approaches of the present invention described above.

The present embodiment shows an example adopting the method (A) described as the basic approaches of the present invention. When the storage battery system 10 is formed by arranging a plurality of the assembled battery systems 100-1 to 100-n to form the storage battery system 10, as shown in FIG. 1, it is necessary to prevent interference between wireless electromagnetic waves inside the metal housing 101. This embodiment shows an example of avoiding interference between the assembled battery systems 100.

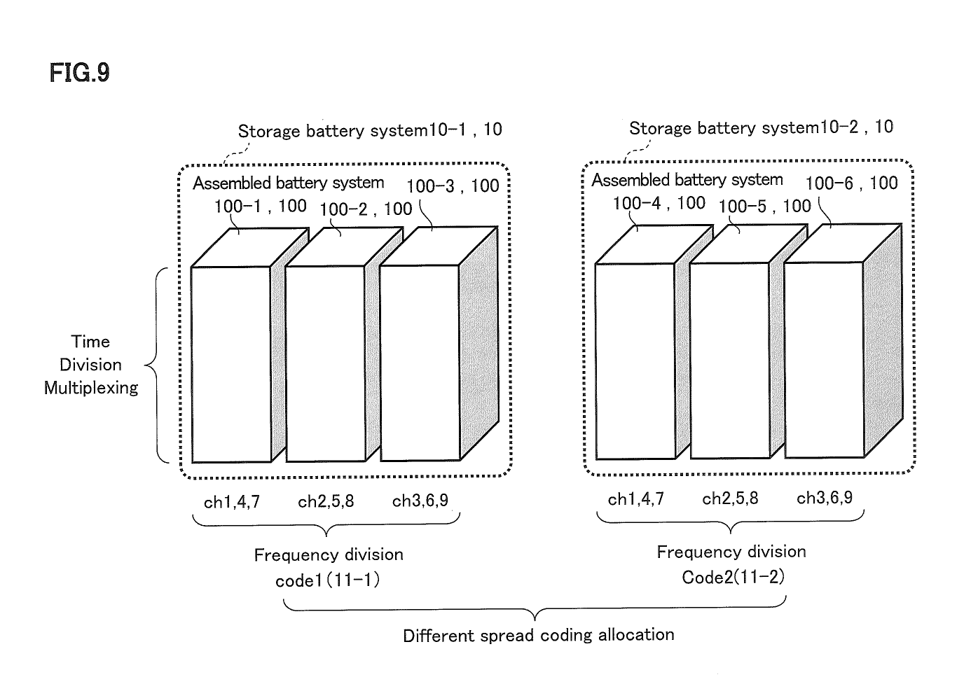

FIG. 9 is a drawing schematically illustrating configuration in a case where a plurality of assembled battery systems are arranged.

In this embodiment, either of communication time, a communication frequency, a communication space, or a spread code is set for each of the assembled battery systems 100-1 to 100-n in the storage battery system 10 formed by arranging a plurality of the assembled battery systems 100 (see FIG. 1).

For example, setting is made such that communication between the storage battery modules 110 is made by time division, communication between the assembled battery systems 100 is made by the frequency division, or communication between the storage battery systems 10 is made by the cord division.

In FIG. 9, the storage battery system 10-1 in which the assembled battery systems 100-1 to 100-3 are adjacently arranged and the storage battery system 10-2 in which the assembled battery systems 100-4 to 100-6 are adjacently arranged are arranged in line. In other words, the storage battery system 10-1 is configured including the assembled battery systems 100-1 to 100-3, and the storage battery system 10-2 is configured including the assembled battery systems 100-4 to 100-6.

### [Between the Storage Battery Modules: Time Division Multiple]

As shown in FIG. 9, inside each of the assembled battery systems 100-1 to 100-6, the managing device 120 (see FIG. 1) performs time-division multiplex communication between each of the storage battery modules 110 forming the assembled battery systems 100-1 to 100-6.

### [Between Assembled Battery Systems: Frequency Division]

To each of the assembled battery systems 100-1 to 100-6, usable frequencies are previously allocated. For example, channels ch1, ch4, and ch7 are allocated to the assembled battery system 100-1, channels ch2, ch5, and ch6 are allocated to the assembled battery system 100-2, and channels ch3, ch6, and ch9 are allocated to the assembled battery system 100-3. Regarding this, a frequency of adjacent pairs of the assembled battery systems 100-1 to 100-6 are set to avoid overlapping. Further, when there are a plurality of channels for the assembled battery systems 100-1 to 100-6 (in this case there are ch1, ch4, and ch7), it is desirable to select and allocate channels which are as far in frequency as possible.

Similarly, channels ch1, ch4, and ch7 are allocated to the assembled battery system 100-4 and channels ch2, ch5, and ch6 are allocated to the assembled battery system 100-5, and channels ch3, ch6, and ch9 are allocated to the assembled battery system 100-6. Further, as described later, though the assembled battery systems 100-1 to 100-3 in the storage battery system 10-1 and the assembled battery systems 100-4 to 100-6 in the storage battery system 10-2 have the same combination of channels ch of the assembled battery systems 100-1 to 100-6, different spread codes are allocated between the storage battery system 10-1 and the storage battery system 10-2.

As described above, a usable frequency are previously allocated to each of the assembled battery systems 100-1 to 100-6 to make setting to avoid overlapping in frequency between the adjacent assembled battery systems 100-1 to 100-6. The frequencies usable for each of the assembled battery systems 100-1 to 100-6 are arbitral determined by setting by the managing device 120 (see FIG. 1), and one or more frequency can be allocated to each of the assembled battery systems 100-1 to 100-6. When more than one channel is allocated to each of the assembled battery systems 100-1 to 100-6, it is desired to select channels ch to have frequencies apart as shown in FIG. 9 to have a sufficiently large change with respect to a band width of the falling in propagation characteristics of electromagnetic waves (see FIG. 6B inside the metal housing 101 (see FIG. 1) to avoid the falling in propagation characteristics of electromagnetic waves inside the metal housing 101 (see FIG. 1). In this embodiment, the channels ch1, ch4, and ch7 are allocated to the assembled battery system 100-1, channels ch2, ch5, and ch6 are allocated to the assembled battery system 100-2, and channels ch3, ch6, and ch9 are allocated to the assembled battery system 100-3, so that channels ch having frequencies which are apart from each other are allocated.

### [Between Storage Battery Systems: Different Spread Code Allocation]

As shown in FIG. 9, when the storage battery system 10-1 and the storage battery system 10-2 are adjacently arranged and the storage battery systems 10-1 and 10-2 use the same frequency, the assembled battery system 100-1 to 100-6 each use a spread spectrum code method, and different spread codes 11-1 and 11-2 are allocated for the storage battery systems 10-1,10-2, respectively. The spread codes 11-1 and 11-2 are spread codes having a low correlation each other. For example, when the spread code 11-1 uses a set A having a symbol length of 32 bits×16 (1 to 16), a set B having a symbol length of 32 bits×16 is used which has a spread code 11-2 which is independent from the spread code 11-1.

To allocate the spread code 11-1 and the spread code 11-2 to the storage battery system 10-1 and a storage battery system 10-2, respectively, the below method is adopted. When the storage battery system 10 including a plurality of assembled battery systems 100 is formed, spread codes are installed in advance as a communication method for the assembled battery systems 100. For example, the managing device 120 of each of the assembled battery system 100-1 to the assembled battery system 100-6 (see FIG. 1) first performs spreading spectrum using the spread code 11-1 for a narrow channel ch (for example ch1) having a narrow band and then frequencies are allocated to the assembled battery systems 100-1 to 100-6 for the spread-coded channel ch1, respectively.

Each of other channels ch is similarly first spread-coded and a frequency is allocated to each of the assembled battery systems 100-1 to 100-6. When there is no other storage battery system 10-2 such as a case where the storage battery system 10-1 is operated alone, or there is no necessity to consider interference from other storage battery system 10-2, the managing devices 120 of the assembled battery system 100-1 to 100-3 do not set the spread code and allocate the frequency. When the storage battery system 10-2 is arranged adjacent to the storage battery system 10-1, and the storage battery system 10-1 and the storage battery system 10-2 use the same frequency, to avoid interference each other, the managing device 120 of each of the assembled battery systems 100-4 to 100-6 allocates the spread code 11-2 different from the spread code 11-1. This causes different spread codes to be allocated between the storage battery systems.

More specifically, to allocate different spread codes between the storage battery systems, on the assumption that the assembled battery system performs spread-coding for the channel ch in advance and the spread-coded channel ch is frequency-divided for each of the assembled battery systems, allocating a spread code different from the spread code used in the previously installed assembled battery system resultantly causes different spread codes are allocated between the storage battery systems.

Further, in the case where frequency allocation is possible for each of the assembled battery system 100-1 to 100-6 without using the same frequency between the storage battery systems 10-1 and 10-2, there is no problem if the method of allocating different spread codes. Further, when the storage battery system 10-1 and the storage battery system 10-2 do not use the same frequency, different spread codes may be set.

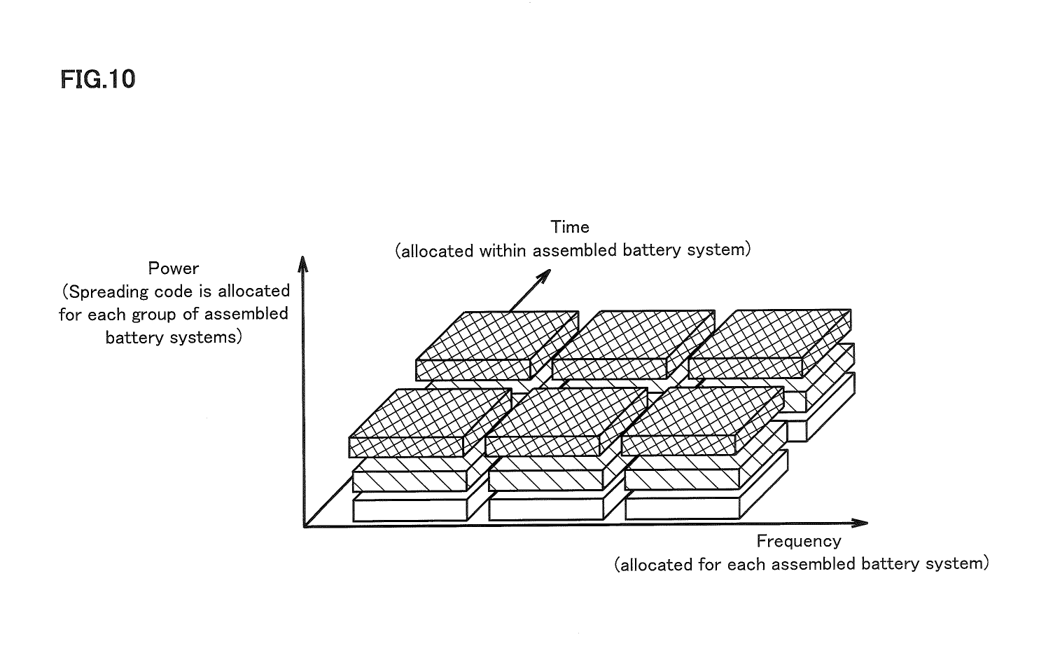

FIG. 10 is a drawing illustrating a method of avoiding interference by a multiple access control method of the assembled battery system shown in FIG. 9.

In FIG. 9, x-axis indicates frequency in allocating to each of the assembled battery systems, y-axis indicates time in allocating to each of the assembled battery systems, and z-axis indicates power in allocating to each of the assembled battery systems.

As shown in FIG. 10, regarding the time-axis, time-division-multiplexing is provided between the storage battery modules in the assembled battery system, regarding frequency-axis, frequency division is provided between the assembled battery systems for each of the assembled battery systems, and regarding power axis, there are spread codes allocated for each group of a plurality of assembled battery systems.

As described above, the assembled battery system 100 according to the present embodiment includes the cell monitoring unit 116 monitoring the battery state of each of the secondary batteries 115 to which the storage battery module 110 belongs, and the controlling unit (storage battery module side managing device) 117 including the wireless communicating unit 118 performing wireless transmission in the metal housing 101 hosing the corresponding storage battery module 110, and the managing device 120 managing respective storage battery modules 110 through bi-directional wireless communication inside the metal housing 101. The managing device 120 transmits measuring commands including information specifying the next measuring timing to respective storage battery modules 110 at a regular interval and performs control to cause the cell monitoring unit 116 measure the battery sates instantaneously between the storage battery modules in accordance with the measuring command. Further, the storage battery system 10 sets either of the communication time, a communication frequency, a communication space, or spread code. In the present embodiment, transmission between the storage battery modules 110 (between the managing device and the storage battery modules) is time-division, transmission between the storage battery modules 110 is a frequency division, and transmission between the storage battery systems 10 is performed by changing spread codes.

Accordingly, a usable frequency channel is allocated for each of the storage battery modules 110 and time-division communication is made inside the storage battery module 110, which avoids interference in and between the storage battery modules 110. Further, between the storage battery systems interference can be avoided each other. As a result, a battery system is provided which can perform communication without interference even if a plurality of assembled battery systems/storage battery systems are arranged side by side.

Further, at a stage of system design, selection is allowed about what type of information is divided at what layer. For example, communication between the managing device 120 in the assembled battery system and each of the storage battery modules 110 may be made by frequency division multiplex and communication between the assembled battery systems 100 may be made by code division, and communication between the storage battery systems may be made by time division.

### Second Embodiment

A second embodiment is an example in which the method (B) is adopted which was described in the basic approaches of the present invention.

Because hardware structure according to the present embodiment is the same as that shown in FIGS. 1 to 4, the same part is designated with the same reference, and a duplicated explanation is omitted. However, the control program executed by the control units of the managing device 120 and the storage battery system controller 20 are different in each of the embodiments.

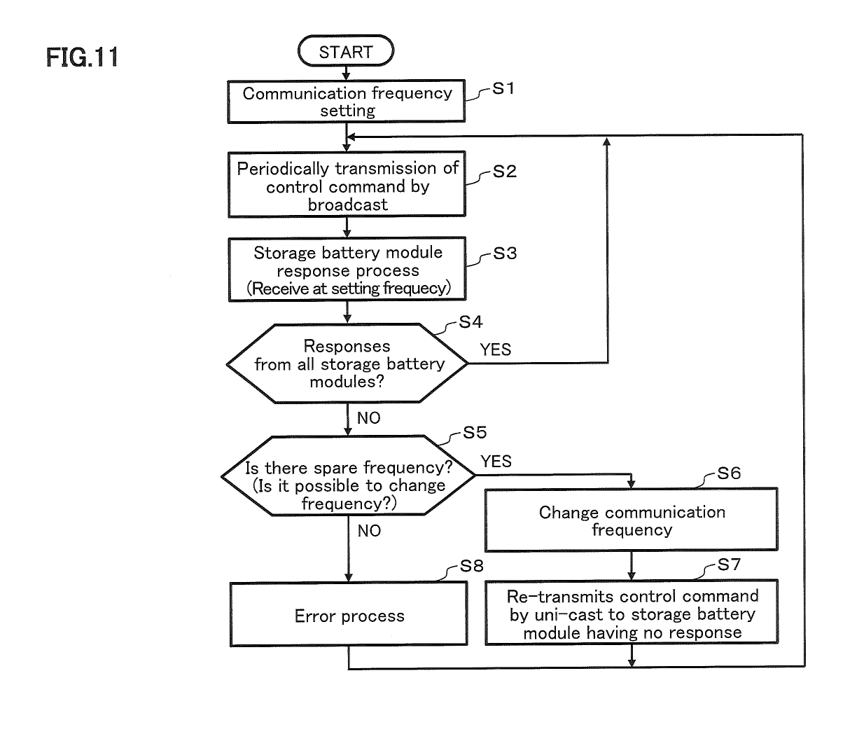

FIG. 11 is a flowchart illustrating communication control of the managing device 120 of the assembled battery system according to the second embodiment. In FIG. 11, “S” indicates each step of the flow.

First, the managing device 120 sets the communication frequencies in a step S1.

In a step S2, the managing device 120 periodically transmits a control command to each of the assembled battery systems 100 by broadcasting. The control command is the measuring command for measuring battery information regarding a cell voltage or a cell temperature, an internal resistance, a remaining charge amount, a charging and discharging state, ID, presence and absent of an error, deterioration degree, etc.

In a step S3, the managing device 120 performs a response process of the storage battery module 110 such as reception at the set frequency.

In a step S4, the managing device 120 determines whether there is a response from all the storage battery module 110 or not.

When there are responses from all the storage battery modules 110, processing is returned to the step S2 to continue the periodical transmission of the control command by broadcasting is continued in the above-described step S2.

When there is no response from all the storage battery modules 110, the managing device 120 determines in a step S5 whether it is possible to change the frequency because there is a spare frequency.

When there is a spare frequency, so that the frequency change is available, the managing device 120 selects, at a step S6, the communication frequency from the spare frequencies and change the communication frequency to the selected communication frequency. The change of the communication frequency is made by, for example, sequentially using predetermined frequencies. In this case, it is desirable that the communication frequency to be used next is a communication frequency at a band of which frequency is as apart as possible.

In a step S7, the managing device 120 re-transmit the control command to the storage battery module 110 having no response by unicasting and returns to the above-described step S2.

When the frequency change cannot be done in the step S5, the managing device 120 conducts an error process at a step S8 and returns to the step S2. The error process outputs that the control command had not been able to be transmitted to the storage battery module 110 having no response. In this case, the managing device 120 can use this as a trigger of transferring to a communication control performing wireless communication via another storage battery module described later. In addition, it may be possible to inform the storage battery system controller 20, being an upper controller, of this matter.

As described above, in this communication flow, the first command is made by broadcasting, and the command is re-transmitted to the storage battery module which cannot receive the command by the unicast after the frequency is changed.

FIGS. 12A to 12E are control sequence drawings illustrating communication control between the managing device 120 according to the present invention and each of storage battery modules 110-1 to 110-4. At a communication cycle T, communication slots (response slots) #1 to #5, re-transmission slots #6 to #9, and a measuring slot #10 are repeated.

In the assembled battery system, it is necessary for the storage battery modules 110 to complete the measurement of the battery states simultaneously for the same time interval. In the case of FIGS. 12A to 12E, the battery information should be measured within the time interval of the measuring slot #10. There is a difference from the general wireless system in that the measurement requires simultaneity.

As shown in FIGS. 12A to 12E, the managing device 120 transmits the control command by broadcasting at a frequency f1 to all the storage battery modules 110-1 to 110-4 at the start slot (slot#1) in the communication slot (response slot).

The storage battery modules 110-1 to 110-4 receive the command transmitted by broadcasting from the managing device 120 at the start slot (slot#1) of the communication slots. The storage battery modules 110-1 to 110-4 respond to the managing device 120 at the frequency f1 in an order of storage battery module IDs.

When receiving the response from the storage battery modules 110-1 to 110-4, the managing device 120 makes a determination between success in communication and error in communication. The managing device 120 receives responses from the storage battery modules 110-1, 100-2, 100-4 at slots #2, #3, #5 and makes the determination of success in communication. However, it is assumed that the assembled battery system 100-3 fails to receive the broadcast because the propagation characteristics at a communication frequency f1 are deteriorated. Because only the storage battery module 110-3 has not received the instruction from the managing device 120, the storage battery module 110-3 does not return the response.

The managing device 120 determines that the communication with the storage battery module 110-3 results in the communication error and re-transmits the control command to the storage battery module 110-3 with the re-transmission slots #6 to #9. The managing device 120 makes a change from the frequency f1 to a frequency f2 and transmits the control command in a re-transmission slot #6 at the frequency f2 to the storage battery module 110-3 by the unicast.

It is assumed that the assembled battery system 100-3 fails to receive the unicast because a propagation characteristic of electromagnetic waves is also deteriorated at the frequency f2. Accordingly, the storage battery module 110-3 has not received the command from the managing device 120, and does not return the response.

The managing device 120 makes a change from the communication frequency f2 to a communication frequency f3 and transmits the control command to the storage battery module 110-3 at a re-transmission slot #8 by the unicast. As described above, when there are a plurality of usable frequency channels, the managing device 120 makes a direct re-transmission to the storage battery module having failed in communication using the frequency.

When receiving a response from the storage battery module 110-3 at the re-transmission slot #9, the managing device 120 makes a determination of the communication success at the frequency f3. The managing device 120 stores, as a table data, that the storage battery module 110-3 can receive communication at the frequency f3 and can use the table data at the next communication control. Further, when the communication result in the communication error even if all the re-transmission slots #6 to #8 are used, or when there is no spare frequency, the managing device 120 can shift to a communication control using a wireless communication via another storage battery module as described later after finish of the communication control.

The managing device 120 performs a control command at the measuring slot #10. The measuring slot #10 is a slot for performing the control command (for measurement). In the assembled battery system, the storage battery modules 110-1 to 110-4 measure the battery states simultaneously within the measuring slot #10. The data measured in response to the control command is transmitted upon the next response.

In addition, the re-transmission slot may be divided into a plurality of storage battery modules. Further, a frame configuration may be provided including slots #10, #1, #2, . . . , #9, wherein the measuring slot #10 is located at the top of the frame.

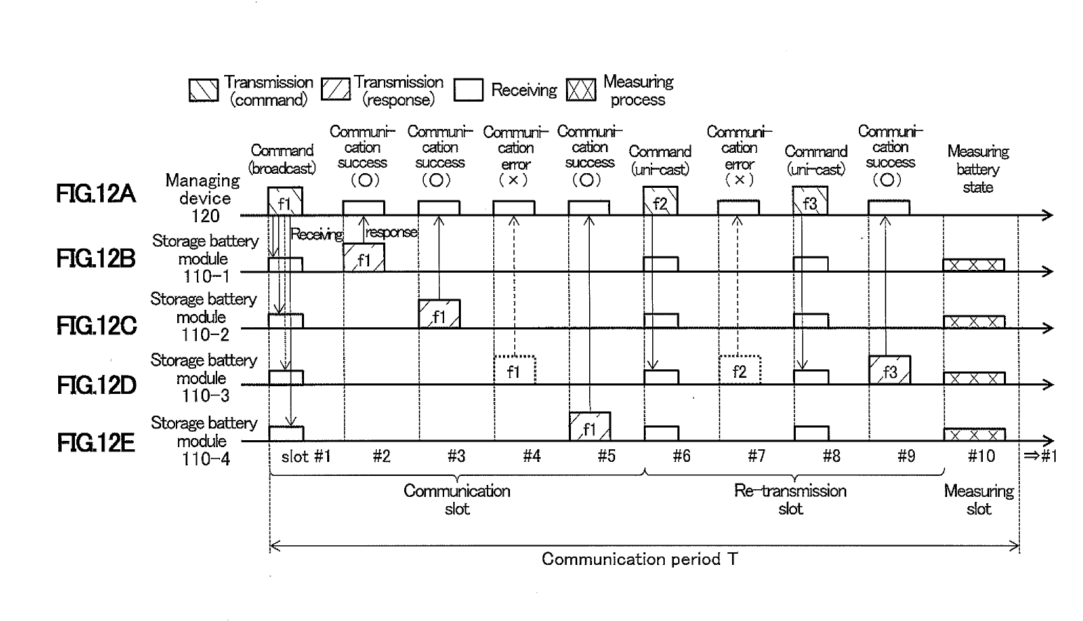

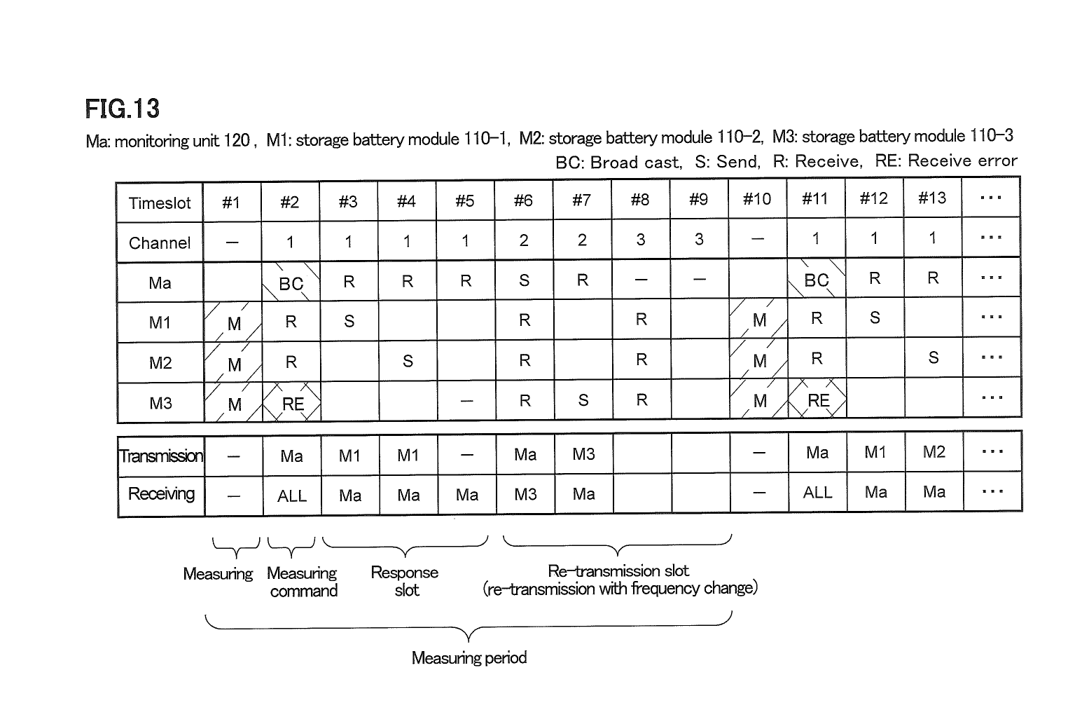

FIG. 13 is a drawing illustrating an example of time-division multiplex communication between the managing device 120 (Ma) and three storage battery modules 110-1 to 110-3 (M1 to M3) in the assembled battery system. In FIG. 13, “M” represents a measurement of the battery information; “Ma” represents the managing device 120, “M1” represents “storage battery module 110-1”; “M2” represents “storage battery module 110-2”; and M3 represents “the storage battery module 110-3”. Further, “BC” in FIG. 13 represents states of “Broadcast” (Broad cast), “S” represents “Transmission” (Send), R represents “reception (Receive), and “RE” represents a “reception error” (Receive error).

As shown in FIG. 13, the communication between the managing device Ma and M1 to M3 is performed based on the time slots made by sectioning time at a constant interval. One of collecting periods includes the time slots of the measurements of the battery information, the measuring command, the responses, and re-transmission.

In FIG. 13, the time slot #1 is assigned as a period for performing the measurements. The time slot #2 is used for transmitting the measuring command, and the measuring command is transmitted to the managing device Ma to all the storage battery modules M1 to M3 by broadcasting.

The measuring command therein includes measurement start timing in the next collecting period, a communication channel allocated to each time slot, and a response order of each of the storage battery modules. For example, each of the storage battery modules M1 to M3 recognizes that a time slot at the next collecting period is #10, and the communication channel and a response order used in a communication after a slot #11.

Since the measurement of the battery state is made on the basis of the measuring command received in the previous measuring period, there is no recent measurement data in the first response of the storage battery modules M1 to M3. Accordingly, either of the data collected in the past, a predetermined initial value, or a vacant data is transmitted as a response data. Further, it is assumed that initial time slots and the frequency allocation have been set to each of the storage battery modules M1 to M3 as initial values.

It is assumed here that, in the communication slot #2, the storage battery module M1 and M2 can correctly receive the broadcast, and the storage battery module

M3 cannot correctly receive the broadcast. The storage battery modules M1, M2 which have correctly received the measuring command transmits recent measurement data to the managing device Ma using the frequency which is the same frequency when receiving the broadcast at predetermined response slots #3, #4, respectively. On the other hand, the storage battery module M3, which cannot receive the measuring command correctly, does not return the response at the time slot #5. The managing device Ma knows that communication with M3 results in fail because there is no response from the storage battery module M3, which were supposed to originally return the response. Accordingly the managing device Ma tries re-transmission to the storage battery module M3 at the next re-transmission slot.

In the assembled battery system 100 (see FIG. 1), it is assumed that usable frequency channels are the channels ch1, ch2, ch3. When the channel ch1 is used for the broadcast, a frequency other than the channel ch1 is set for the re-transmission slot. For example, in the system shown in FIG. 13, the channel ch1 is used for the broadcast, the measuring command, and response, the channel ch2 is allocated for the time slots #6, #7 for re-transmission, and the channel ch3 is allocated to time slots #8, #9. When the communication at the channel ch1 is failed due to deterioration in a propagation environment of electromagnetic waves, falling in propagation characteristics of electromagnetic wave can be avoided by changing the communication channel upon re-transmission.

In the time slot #6 for re-transmission, the managing device Ma re-transmits the measuring command to the storage battery module M3 which has been unable to communicate. A storage battery module M3, having correctly received the measuring command, returns the response in the time slot #7. When it is confirmed that responses are returned from all the storage battery modules M1 to M3, transmission and reception are not performed in the surplus slots #8 and #9.

In the case where the broadcast has been correctly received from the monitoring unit Ma and has been incorrectly received from each of monitoring units M1 to M3, similarly, the monitoring unit Ma performs the re-transmission process to each of the storage battery modules M1 to M3. Since the storage battery modules M1 to M3 cannot previously know whether the monitoring unit Ma performs the re-transmission process, setting is previously made to prepare the re-transmission of the measuring command form the monitoring unit Ma to cause the channel ch2 to be a reception state in the time slots #6 and the channel ch3 to be reception state in the time slot #8.

After completion of the measuring cycle from the time slots #1 to #9, each of the storage battery modules simultaneously measures in response to the measuring command in the time slot #1, which is a top slot in the next measuring period. Hereinafter the monitoring unit Ma can periodically collects the battery information of the secondary battery 115 (see FIGS. 3 and 4) by repeating this operation.

Further, there may be such a configuration that the time for performing the measurement and time for measuring command extending in a plurality of time slots. The number of the time slots for response is determined to be equal or more the number of the storage battery modules at least, and the response order from the storage battery modules can be previously set without transmission by the broadcast. Further, it is assumed that there are provided two slots or more for re-transmission.

As described above, in the assembled battery system 100 according to the present embodiment, the managing device 120 transmits the measuring command to each of the storage battery modules 110 by the broadcast and transmits by the unicast upon the re-transmission. Further, the storage battery module 110 transmits the measured battery information to the managing device individually. Accordingly the assembled battery system 100 can shorten the communication time period and the entire storage battery modules 110-1 to 110-4 can measure the battery state simultaneously within the measuring time period.

Particularly, in the present embodiment, the managing device 120 performs the first measuring command by the broadcast and performs the re-transmission of the measuring command to the storage battery module 110 which the measuring command cannot reach. In this operation, if there is another usable frequency channel, the re-transmission is directly performed using this frequency. Further when there is no response from the storage battery module 110 within a period for receiving response, the managing device 120 determines that the communication is failed. When a selection can be made among a plurality of communication frequencies in the storage battery module 110, the re-transmission of the measuring command is made to the corresponding storage battery module after changing the communication frequency in accordance with the predetermined procedure. Even if this causes a multiple path inside the metal housing 101 (the storage battery module 110), so that deterioration in the propagation characteristics of electromagnetic waves occurs, the measuring command can be transmitted over the whole of the system. Accordingly, the deterioration in the communication quantity can be avoided. As a result, there is provided the communication method in which the wireless communication can be made even in the inside of the metal housing 101 where the multi-pass occurs.

### Third Embodiment

The third embodiment illustrates an example of the method of the basic approach (C), which was described in the basic approaches of the present invention.

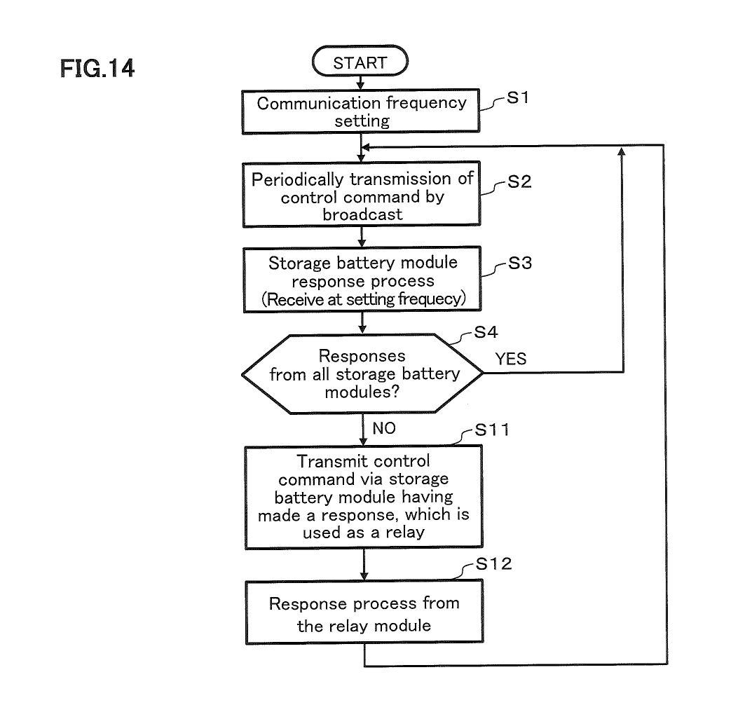

FIG. 14 is a flowchart illustrating a communication control for the managing device 120 of an assembled battery system according to a third embodiment of the present invention. Steps performing the same process as those in FIG. 11 are designated with the same step numbers and the description is omitted.

In FIG. 14, the managing device 120 determines in the step S4 whether there are responses from all the storage battery modules 110 or not.

When there are responses from all the storage battery modules 110, processing is returned to the step S2 to continue the periodical transmission of the control command by broadcasting is continued in the above-described step S2.

When there is no response from all the storage battery modules 110, the managing device 120 selects an appropriate one from the storage battery modules 110 having made responses as a relay and transmits the control command thereto. Preferably, the managing device 120 may select one of the storage battery modules having a secondary battery with a high SOC as a relay device.

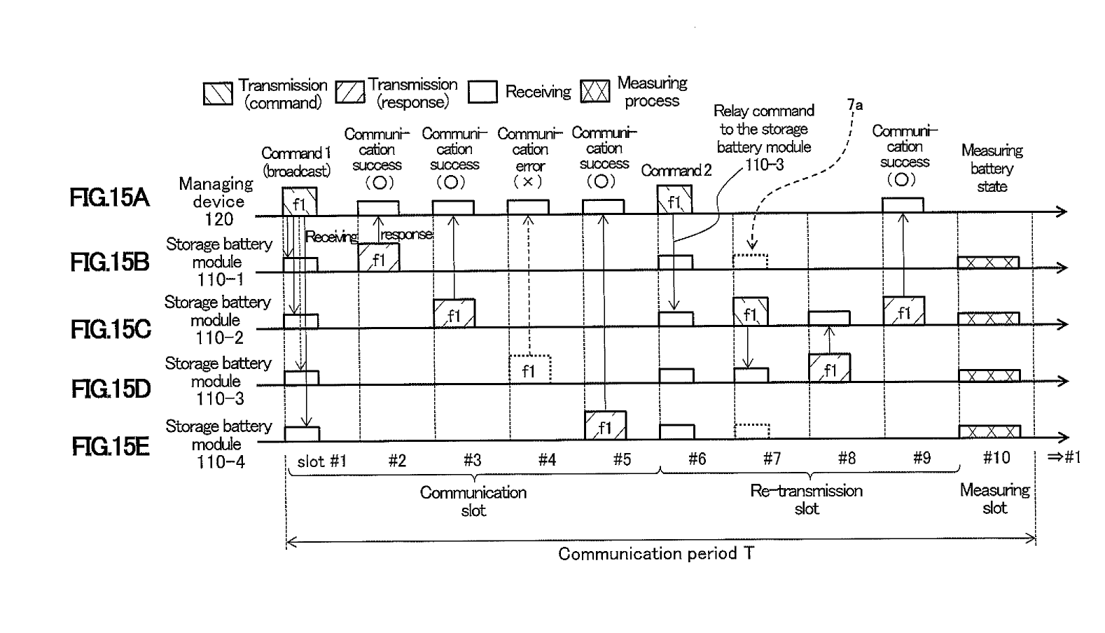

FIGS. 15A to 15E are control sequence drawings illustrating communication control between the managing device 120 for the assembled battery system and each of storage battery modules 110-1 to 110-4 according to the third embodiment. The communication slots (response slot) #1 to #5, re-transmission slots #6 to #9, and the measuring slot #10 are repeated at a communication cycle T. The same part as those in FIGS. 12A to 12E is designated with the same number.

As shown in FIGS. 15A to 15E, the managing device 120 transmits the control command by broadcasting at the frequency f1 to all the storage battery modules 110-1 to 110-4 in a starting slot (slot#1) of the communication slots (response slot).

The storage battery modules 110-1 to 110-4 receive the command transmitted from the managing device 120 by the broadcast in the start slot (slot #1) of the communication slots.

The storage battery modules 110-1 to 110-4 respond to the managing device 120 at a communication frequency f1 in an order of the storage battery module ID.

The managing device 120 receives the responses from the storage battery modules 110-1 to 110-4 to determine whether the communications result is in success/communication error. The managing device 120 receives the responses from the storage battery modules 110-1, 100-2, 100-4 in the time slots #2, #3, #5 to determine whether the communication is successfully done. However, it is assumed that the storage battery module 100-3, having a deteriorated propagation characteristics of electromagnetic waves with the managing device 120 at the frequency f1, fails to receive the broadcast. Accordingly only the storage battery module 110-3 does not return a response because of no reception of the command from the managing device 120.

The managing device 120 determines that a storage battery module 110-3 is in a communication error, selects an appropriate storage battery module 110-2 out of the storage battery modules 110-1,110-2,110-4 as a relay device, and transmits the control command thereto. The managing device 120 can make a relaying command in order of the storage battery module ID to cause the storage battery module to operate as the relay device. However, it is more preferable to select, for example, the storage battery module 110-2 having a higher SOC. Further, it can be determined in consideration of positional relation with the storage battery module 110-3. The managing device 120 transmits the command to the storage battery module 110-3 as described above, so that the command is transmitted via the storage battery module 110-2. Upon re-transmission, multihop communication is used.

The storage battery module 110-2, having become the relay device in response to the relay command, transmits the control command at the frequency f1 using the re-transmission slot #7 to the storage battery module 110-3. Regarding this, though the broadcast at the frequency f1 from the managing device 120 to the storage battery module 110-3 has failed, there is a possibility to succeed in communication between the storage battery module 110-2 and the storage battery module 110-3 even if the same frequency f1 is used. Further, as shown in FIGS. 15A to 15E, among the storage battery module 110-1, 110-2, 110-4 having responded, when there is no relay command at timing 7a, the storage battery modules 110-1, 110-4, having determined that there is no relay command or the re-transmission command is not for its own in the re-transmission slot #6, sleep.

The storage battery module 110-3 receives the control command transmitted via the storage battery module 110-2 in the re-transmission slot #7 and returns a response to the storage battery module 110-2 at the frequency f1 in the re-transmission slot #8.

The storage battery module 110-2 transmits the response from the storage battery module 110-3, which has relayed in the re-transmission slot #9 to the managing device 120.

The managing device 120 receives the response from the storage battery module 110-3 transmitted via the storage battery module 110-2 in the re-transmission slot #9 and determines that the communication succeeds. The managing device 120 stores as the table data that the storage battery module 110-3 is able to receive a signal via the storage battery module 110-2 using the frequency f1, so that the table data is stored and able to be used for the next communication control. Further, when a communication error occurs even though the storage battery module 110-2 is used as the relay device, the managing device 120 may make the wireless communication via another storage battery module as a relay device.

The managing device 120 executes the control command in the measuring slot #10. The measuring slot #10 is a slot for execution control command (measuring command). In the assembled battery system, all the storage battery modules 110-1 to 110-4 measure the battery states simultaneously within the time period of the measuring slot #10. The data measured by the control command is transmitted on the next response.

Further, the re-transmission slots may be provided enough for a plurality of the storage battery modules. Further, a frame configuration may be such that the measuring slot #10 is located at a top, which is followed by slots #1, #2, - - - , #9. Further, frequency information for the next broadcast is caused to be included in the commands 1 and 2 shown in FIG. 15A makes it possible to change the communication frequency for the whole on and after the second communication.

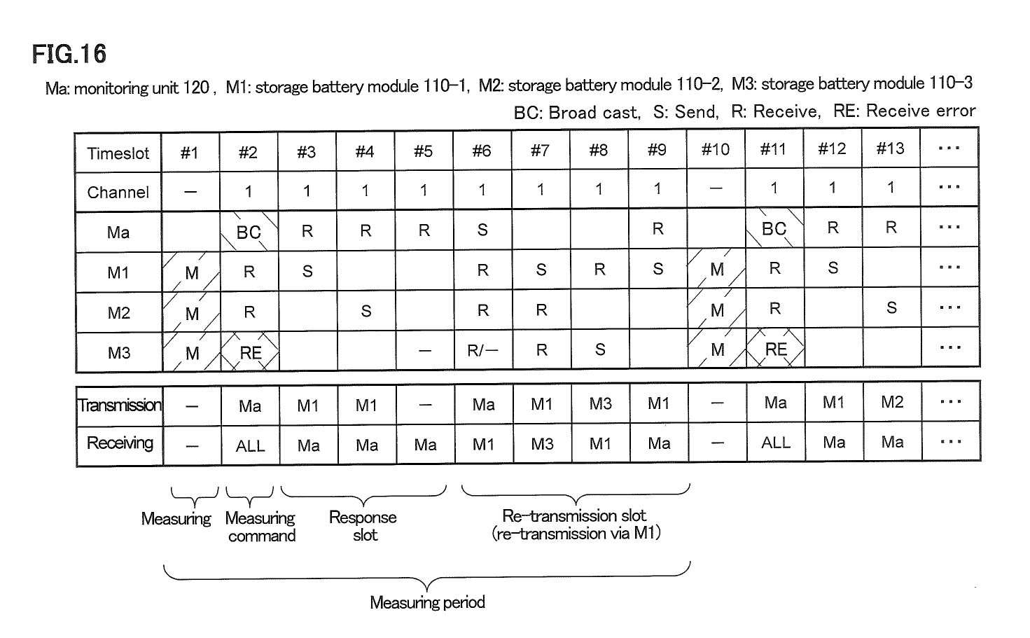

FIG. 16 is a drawing illustrating an example of performing time-division-multiplex communication between the managing device 120 (Ma) and the three storage battery modules 10-1 to 110-3 (M1 to M3) inside the assembled battery system according to the third embodiment. The same part as that in FIG. 13 is designated with the same reference number.

As illustrated by FIG. 16, communication between the managing device Ma and the storage battery modules M1 to M3 is performed based on the time slots which is acquired by sectioning at a regular interval on to have a constant gap defined. One collecting cycle includes time slots of the battery information measurement, the measuring command, the response, and the re-transmission.

In FIG. 16, the time slot #1 is allocated to time for performing the measurement. The time slot #2 is used for transmission of the measuring command, and the measuring command is transmitted to the entire storage battery modules M1 to M3 from the monitoring unit Ma by the broadcast.

It is assumed that the storage battery module M3 cannot correctly receive the measuring command (broadcast) transmitted by the monitoring unit Ma in the time slot #2 due to multi-path, etc. The storage battery modules M1 and M2 return responses in the slots #3, #4 using the frequency channel 1 which is the same as the frequency channel when the broadcast is received, respectively. However, the storage battery module M3 which was unable to correctly receive the measuring command does not return the response in the time slot #5. The monitoring unit Ma determines that the communication with the storage battery module M3 is failed because there is no response from the storage battery module M3 which should originally come in the slot #5 and tries re-transmission to the storage battery module M3 in the following re-transmission slot.

Regarding this, when the channel 1, which is the same as the response channel, is also allocated to the re-transmission slots #6 to #9 due to a request by the system, etc., even if the re-transmission to the storage battery module M3 from the monitoring unit Ma in the re-transmission slot is tried, there is a large possibility in that the communication will be failed because deterioration in the propagation characteristics of electromagnetic wave due to multi-path also occurs. Accordingly, the monitoring unit Ma does not make a direct communication to the storage battery module M3, but selects one from the storage battery modules M1, M2 having transmitted responses (here, the storage battery module M1 is selected) and request the storage battery module M1 to relay the command to a storage battery module M3 in the time slot #6. Regarding this, it is assumed that the monitoring unit Ma can arbitrary select the storage battery module 110 to be commended for relaying. It is preferable that the monitoring unit Ma selects as a relaying device the storage battery module 110 including a secondary battery having a high SOC.

As described above, it is possible to transmit the measuring command to the storage battery module M3 using the channel 1 by relaying without using the propagation path between the monitoring unit Ma to the storage battery module M3 of which propagation characteristics of electromagnetic wave has been deteriorated. If it is assumed that a module of the storage battery module M1 receives the relaying command, the storage battery module M1 transmits the command to the storage battery module M3 in the next time slot #7 and the storage battery module M3, having received the command, and returns the response to the storage battery module M1 in the time slot #8. The storage battery module M1, having received the response, transmits the response by the storage battery module M3 to the monitoring unit Ma in the time slot #9, so that the measuring command can be transmitted to all the modules.

Regarding this, because there is a possibility that the storage battery module other than the storage battery module M3, which apparently did not return a response, may be commanded to relay by the monitoring unit Ma in the time slot #6, the storage battery modules are waiting in a receiving state in the time slot #6. The storage battery module M3, having not returned the response, determines that the relaying command comes to its own, so that the receiver can be stayed rest in the time slot #6. Regarding the slot for re-transmission, it is possible to prepare a plurality (multiples of four) of re-transmission slots because the re-transmission for one storage battery module 110 using four slots (slots #6 to #9). Thereafter, the next measuring period starts after time slot #10.

Though there is only one frequency channel, the measuring command can be transmitted to all the storage battery modules 110 by repeating this operation.

As described above, when the managing device 120 cannot receive the response from the storage battery module, out of the storage battery modules, which were able to receive the response, a predetermined storage battery module is selected as a relay device to cause the storage battery module to relay the response of the measuring command and the battery information. Accordingly, it is possible to transmit the measuring command to the whole of the system, which is similar advantageous effect as that in the second embodiment, so that a stable wireless communication is provided though the propagation characteristics of electromagnetic wave becomes deteriorated at a specific frequency due to multi-path inside the storage battery module 110. In addition to the advantageous effect, because another storage battery module of which response can be received is caused to relay the measuring command and a response of the battery information, there is a specific advantageous effect in that the measuring command can be transmitted to all the storage battery modules though the communication frequency cannot be changed inside the assembled battery system, the communication cannot be provided even if the frequency is change, or there is only one allocated frequency.

### Fourth Embodiment

A fourth embodiment is an example in which the re-transmission methods of the second and third embodiments are combined. In the fourth embodiment, switching functions for communication channels in the measuring command slot and the response slot.

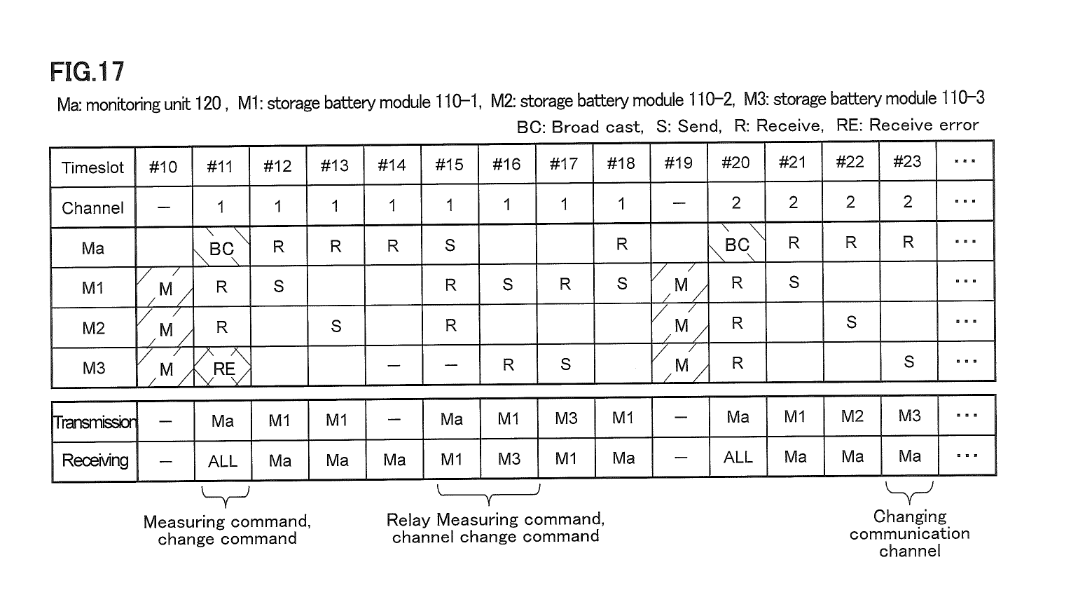

FIG. 17 is a drawing illustrating an example in which the time-division-multiplex communication is performed between the managing device 120 (Ma) and the three storage battery modules 110-1 to 110-3 (M1 to M3) a managing device and a storage battery module of an assembled battery system according to a fourth embodiment of the present invention. The same part as that in FIG. 13 is designated with the same reference.

As described in FIG. 17, the monitoring unit Ma determines that the communication with the corresponding battery module failed because of no response from the storage battery module in the response slot and perform the re-transmission process, as well as the monitoring unit Ma can determine that a stable communication cannot be provided with the storage battery module in the response slot, and the monitoring unit Ma can determine that a stable communication can be provided in a specific channel through one or more communication fails experiment. Regarding this, the frequency can be changed by changing information of the communication channel in the next collecting cycle included in the measuring command, so that the frequency can be changed.

The present embodiment has a feature in changing the communication channel upon using the re-transmission method according to the third embodiment.

The monitoring unit Ma transmits the measuring command (broadcast) by broadcasting in the time slot #2. When the module of the storage battery module M3 cannot receive the broadcast, the storage battery module M3 does not return the response in the time slot #5, which is previously allocated for receiving. The monitoring unit Ma determines that the communication with the storage battery module M3 has failed because there is no response which is expected to be transmitted in the time slot #5, and tries re-transmission to the storage battery module M3 in the method disclosed in the third embodiment in the following re-transmission slot. Further, the monitoring unit Ma transmits a command for changing the communication frequency in the next measuring period because the communication with the storage battery module M3 failed. This means that it is transmitted to each of the storage battery modules M1 to M3 that the channel 2 is used in the measuring period from the next time slot #20 when the measuring command is broadcasted using the channel 1 in the time slot #11. When the communication with each of the storage battery modules in the communication channel 2 does not fail, the channel 2 can be continuously used after that.

### Fifth Embodiment

A fifth embodiment illustrates an example in which it is applied to methods of performing transmission or performing reception in which a plurality of frequencies are switched in the time slot.

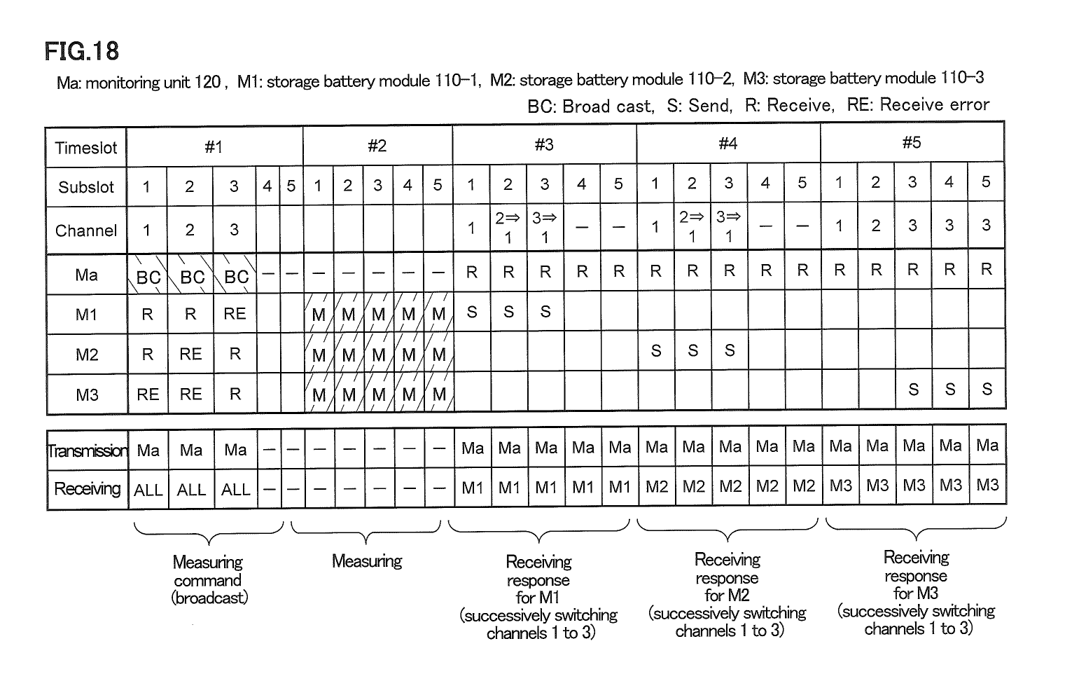

FIG. 18 is a drawing illustrating an example in which time-division multiplex communications made between the managing device 120 (Ma) in the assembled battery system according to the fifth embodiment and the three storage battery modules 110-1 to 110-3 (M1 to M3). FIG. 18 illustrates a method of transmission or reception with switching among a plurality of frequency in the time slot. Each of the time slots is formed with a plurality of sub-slots to which frequency channels are assigned for communication, respectively.

As illustrated in FIG. 18, in the time slot #1, the measuring command is transmitted by broadcasting while the managing device 120 (Ma) is changing the frequency. That is, the monitoring unit Ma performs transmission while the frequency is switched such that the monitoring unit Ma transmits the measuring command using the channel 1 in the sub-slot (#1-1) of the time slot #1; the channel 2, in the sub-slot(#1-2) of the time slot #1; and the channel 3, in the sub-slot(#1-3) of the time slot #1. In this instance, reception is made while the channel is changed for each of the sub-slots on the storage battery module side. However, since at the first communication, the monitoring unit Ma is not synchronous with the storage battery modules M1 to M3, the broadcast can be received by each of the storage battery modules by switching the frequency randomly which is selected from previously set frequencies. Accordingly, even if reception is failed due to deterioration in the propagation characteristics of electromagnetic waves at one of the frequencies, the measuring command can be received at either one of the frequency by transmitting the measuring command while switching is made among a plurality of predetermined frequencies. Unlike the second to fourth embodiments, a time slot for measurement is provided just after the broadcast. This is because it is possible to transmit the measuring command to all the storage battery modules by transmitting the measuring command while the frequency is changed.

The storage battery modules M1 to M3, having received the measuring command, make measurements regarding the storage battery information in the time slot #2. The time slot #3 is time period allocated to a response by the storage battery module M1, and a different channel is allocated to each of sub-slots in the communication with the monitoring unit Ma. For example, the channel 1 is allocated to #3-1, the channel 2 is allocated to #3-2, and the channel 3 is allocated to #3-3. The storage battery module M1 returns the response in the channel 1 having first received and starts the transmission from #3-1. Once the communication is started in the channel 1, the communication can be continued in the channel 1 until the communication has finished or the time period up to completion of the time period #3. Accordingly, when the transmission data is too long, the communication is allowed over the #3-2 and #3-3.

The time slot #4 is a time period allocated to the response by the monitoring unit M2. In the communication with the monitoring unit Ma, #4-1 is allocated to the channel 1, #4-2 is allocated to the channel 2, and the channel 3 is allocated to #4-3. The storage battery module M2 starts to return the response in #4-1 because the storage battery module M2 has received the measuring command in the channel 1.

A time slot #5 is a time period allocated to the response by the storage battery module M3. Similar to time slots #3 and 4, frequencies for response are allocated to each of the sub-slots. In FIG. 18, in the time slot #1, the storage battery module M3 fails to receive the measuring command in the channel 1 and channel 2 and receives the measuring command in the channel 3. The storage battery module M3 determines that the propagation characteristics of electromagnetic waves with the monitoring unit Ma deteriorate and starts to return the response using a sub-slot 5-3 in the channel 3. The monitoring unit Ma repeats this operation and can collect the measured information at each of periods.

### Sixth Embodiment

A sixth embodiment is an example in which it is applied to a method of performing the communication with each of the storage battery modules by polling without using broadcasting.

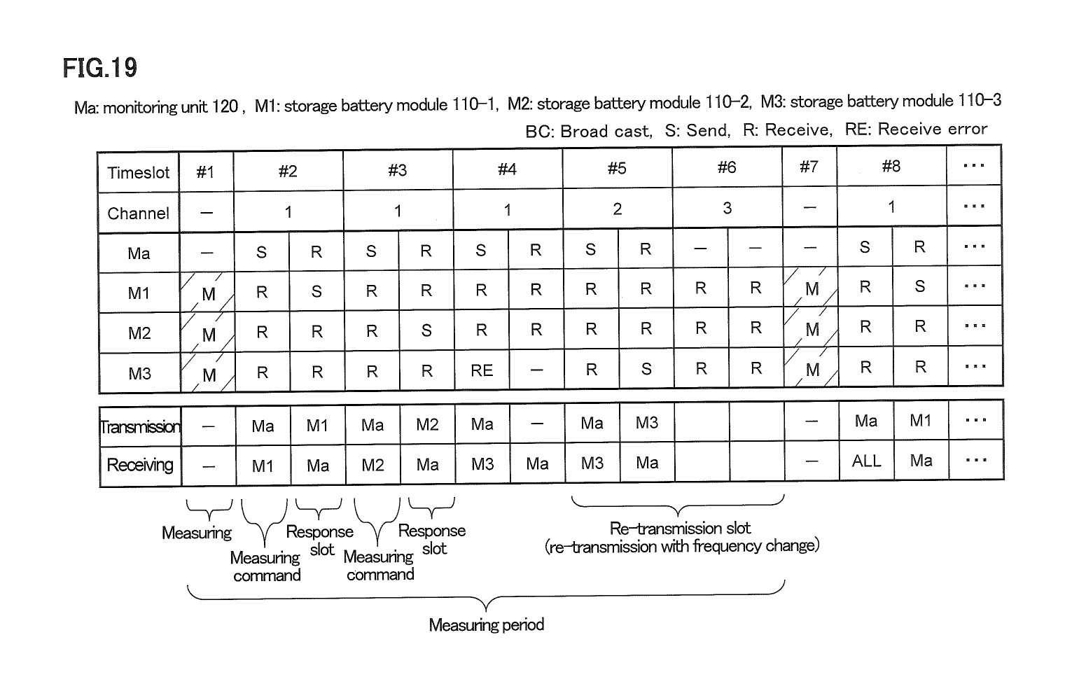

FIG. 19 is a drawing illustrating an example in which the time-division-multiplex communication is performed between a managing device 120 (Ma) and three storage battery modules 110-1 to 110-3 (M1 to M3) of an assembled battery system according to the sixth embodiment of the present invention. FIG. 19 illustrates the method of communication with each of the storage battery modules by polling without using broadcasting.

As shown in FIG. 19, the measurement for the battery information of each of the storage battery modules M1 to M3 is made in the time slot #1. In the time slots #2 to #4, the measuring command and the response are made for each of the storage battery modules. In this operation, the communication frequency is fixed at the channel 1. In the time slot #2, the monitoring unit Ma transmits the measuring command to the storage battery module M1. The storage battery module M1, having received the measuring command, returns the data measured within the same time slot #2. Similarly, the monitoring unit Ma and the storage battery module M2 perform communication in the time slot #3, and in the time slot #4, the monitoring unit Ma and the storage battery module M3 perform communication. In the time slot #4, when the communication with the storage battery module M3 is failed, the storage battery module M3 does not return the response to the monitoring unit Ma. Because there is no response from the storage battery module M3, the monitoring unit Ma determines that the communication is failed, and performs the re-transmission in the time slots #5 and #6. Similarly, the re-transmission process is performed in the case where the storage battery module M3 receives the measuring command and returns the response and the monitoring unit Ma fails in the reception.

When communication with the storage battery module M3 is failed in the time slot #4, the monitoring unit Ma determines that the propagation characteristics of electromagnetic waves in the channel 1 is deteriorated during the communication with the storage battery module M3 and performs re-transmission in the time slot #5 with the communication channel being changed. The storage battery module M3, having received the measuring command in the time slot #5, returns the response in the same time slot #5. In the time slot #6, the re-transmission process is performed with the channel being changed to the channel 3. However, when the responses can be received from all the storage battery modules, communication is not performed in the remaining re-transmission slots.

### Seventh Embodiment

A seventh embodiment illustrates an example in which the communication with each the storage battery modules is applied to the method of communication with each of the storage battery modules using polling without using broadcasting.

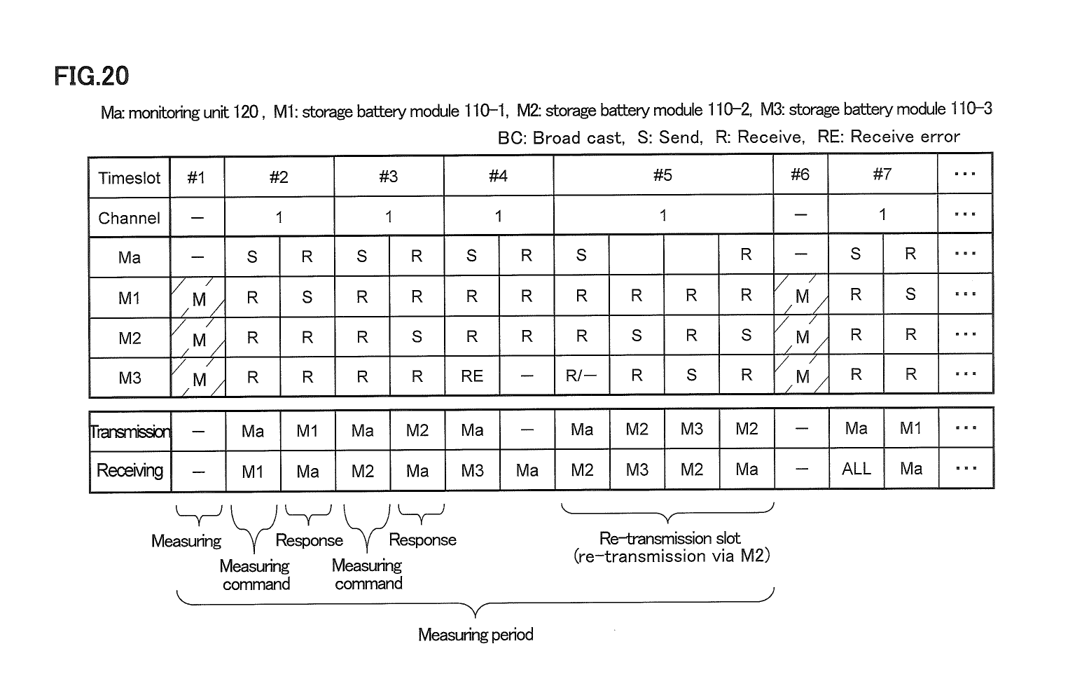

FIG. 20 is a drawing illustrating an example in which the time-division-multiplex communication is performed between the managing device 120 (Ma) and the three storage battery modules of an assembled battery system according to a seventh embodiment of the present invention. The same parts as those in FIG. 19 are designated with the same numbers.

Similar to the sixth embodiment, in the seventh embodiment, the communication with each of the storage battery modules 110 is performed by the method of polling, but there is difference in the method of re-transmission. Similar to the sixth embodiment, when communication with the storage battery module M3 in the time slot #4 is failed the monitoring unit Ma determines that the propagation characteristics of electromagnetic waves in the channel 1 with the storage battery module M3 is deteriorated, and performs the re-transmission after changing the communication path in the time slot #5. For example, the monitoring unit Ma transmits the measuring command for the storage battery module M3 to the storage battery module M2 in the time slot #5.

The storage battery module M2, having received the measuring command for the storage battery module M3, performs the function of a relay between the monitoring unit Ma and the storage battery module M3 to forward the measuring command to the storage battery module M3. The storage battery module M3, having received the measuring command from the storage battery module M2, returns a response to the storage battery module M2. The storage battery module M2, having received the response from the storage battery module M3, forwards the data of the storage battery module M3 to the monitoring unit Ma. This is repeated to transmit the measuring command to all the storage battery modules without change in channel, so that the monitoring unit Ma can periodically collect the storage battery information. Further, it is not always necessary that the time slot for re-transmission occurs at the same time as that of other time slots, but may be set arbitrary the time for the re-transmission.

### Eighth Embodiment

In an eighth embodiment, an application example of broadcast transmission and an example of which communication band is expanded are described.

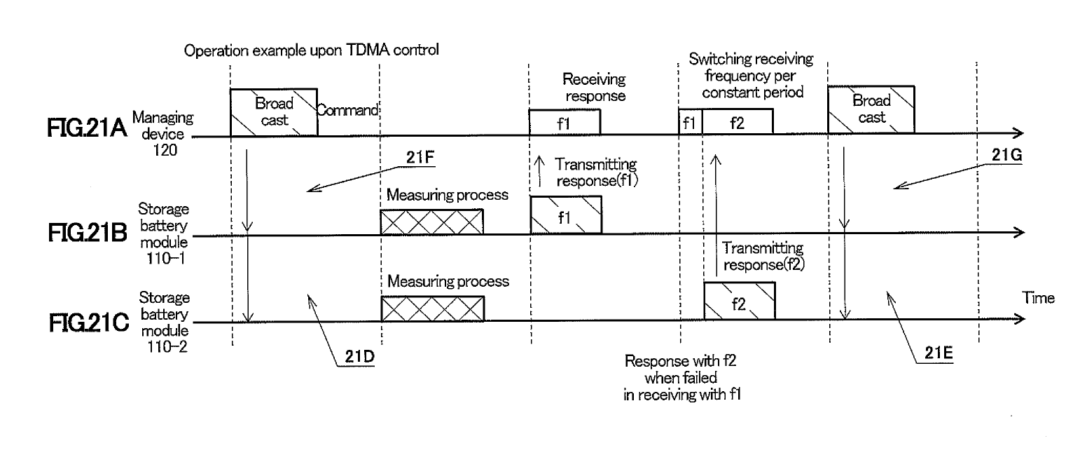

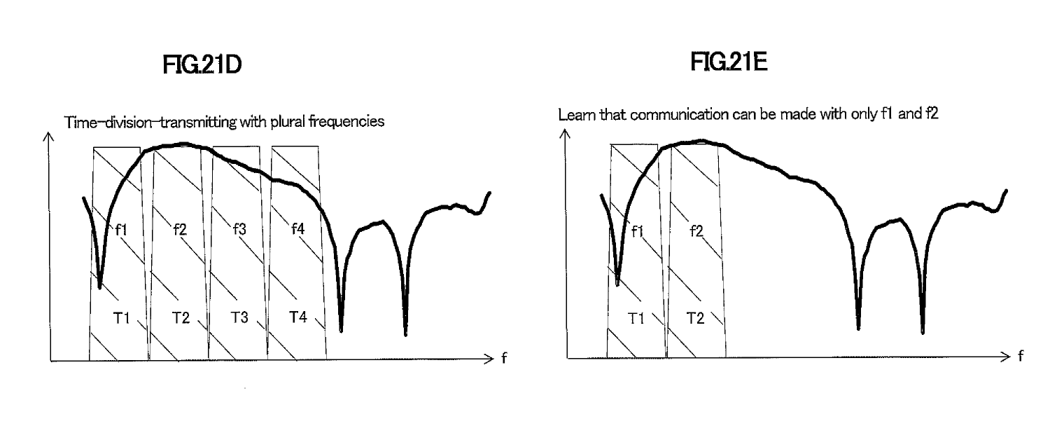

FIG. 21A to 21C are control sequence drawings illustrating a communication control between the managing device 120 and each of the storage battery modules 110-1 to 110-2 according to the eighth embodiment. FIG. 21D illustrates a view pointed by an arrow 21D in FIG. 21C. FIG. 21E illustrates a view pointed by an arrow 21E in FIG. 21C. FIG. 21F illustrates a view pointed by an arrow 21F in FIG. 21B. FIG. 21G illustrates a view pointed by an arrow 21G in FIG. 21B. FIG. 21A to 21G illustrate an operation example during TDMA controlling.

As shown in FIGS. 21A to 21G, the managing device 120 transmits the control command using a spare channel assigned to each of an assembled battery within a single time slot upon broadcast transmission. Regarding this, when there is spare in the time slot, it is allowed to transmit broadcast several times using a plurality of time slots. More specifically, as shown in FIG. 21D (an arrow 21D in FIG. 21C), transmission is made at a plurality of frequencies f1 to f4 at a divided time periods T1 to T4.

After the broadcast, immediately, simultaneous measurement is allowed by inserting information of measuring timing inside the broadcast.

After measuring process, the storage battery module 110-1 transmits a response to the managing device 120 at the communication frequency f1. Further, the storage battery module 110-2 transmits the response at the communication frequency f2 to the managing device 120. The storage battery module 110-2 has either of a function of transmitting a response at a communication frequency f2, or a function of transmitting a response at the communication frequency f2 when reception at the communication frequency f1 cannot be provided. The managing device 120 can receive at both the communication frequencies f1, f2 by switching the receiving frequency is switched at a constant interval.

As shown in FIG. 21b, because the managing device 120 learns that the communication is allowed using only f1 and f2, upon the next transmission of the broadcast, when transmission is made with a transmission period being divided between the frequencies f1 and f2, time-division transmission is made with time periods T1 and T2 at the frequencies f1 and f2.

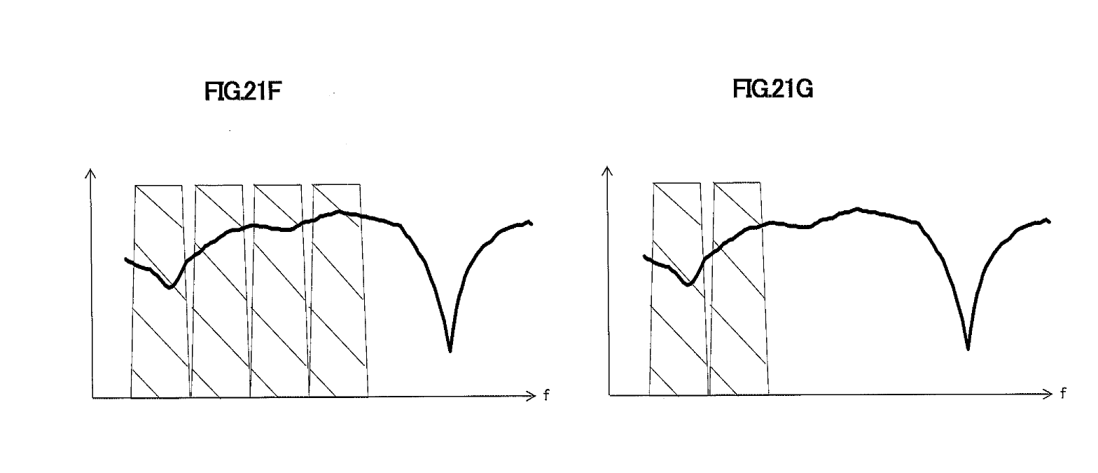

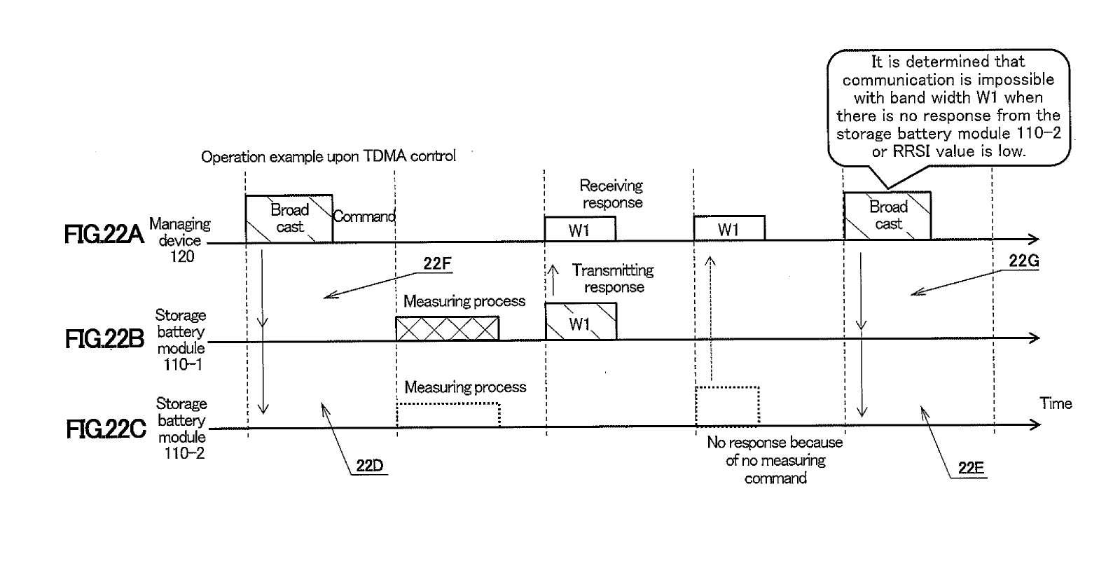

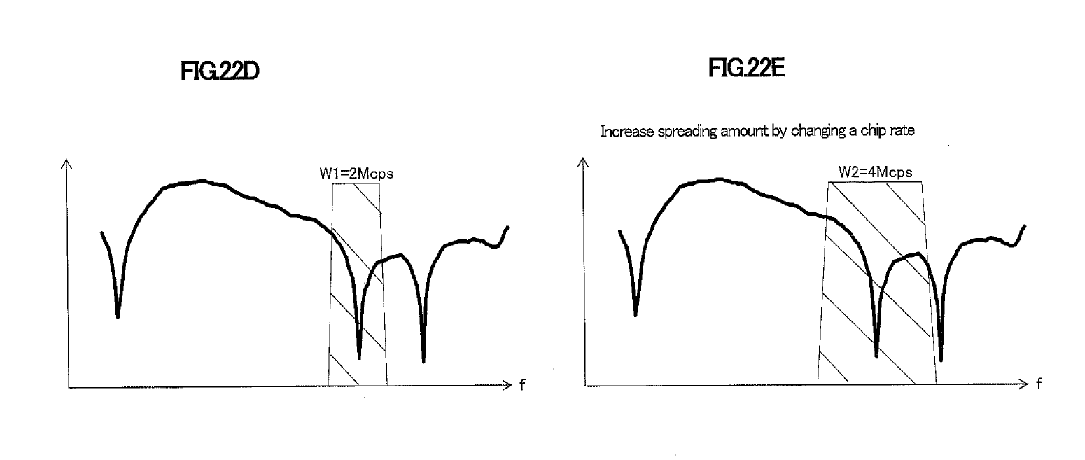

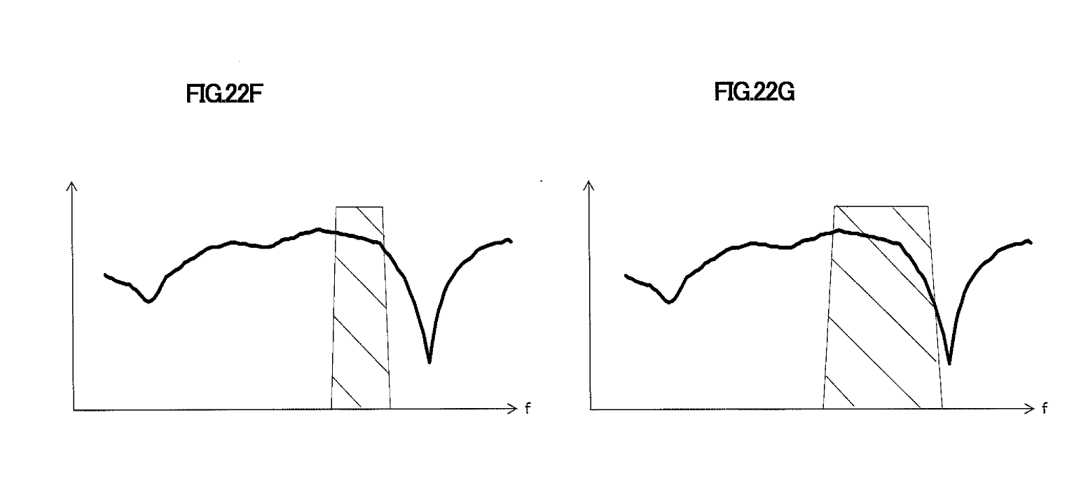

FIG. 22A to 22G are control sequence drawing illustrating a communication control between the managing device 120 and each of the storage battery modules 110-1 to 110-2 according to the eighth embodiment. FIG. 22A to 22G illustrates an operation example upon a TDMA control. FIG. 22D illustrates a view pointed by an arrow 22D in FIG. 22C. FIG. 22E illustrates a view pointed by an arrow 22E in FIG. 22C. FIG. 21E illustrates a view pointed by an arrow 21E in FIG. 22C. FIG. 22F illustrates a view pointed by an arrow 22F in FIG. 22B. FIG. 22G illustrates a view pointed by an arrow 22G in FIG. 22B.

As shown in FIG. 22D (an arrow 22D in FIG. 22C), when the propagation characteristics of electromagnetic waves in the communication channel used by the storage battery module 110-2 is deteriorated, the broadcast from the managing device 120 cannot be received, so that the measuring process cannot be performed. Because of no measuring command, the response is not transmitted to the managing device 120.

Accordingly, the falling is avoided by adoptively expanding the frequency band in the assigned frequency channel. More specifically, when the communication is impossible, a configuration causing the spreading amount to be increased is adopted. However, to adopt the configuration, it is necessary to modify the hardware.

As shown in FIG. 22A (Second Occurrence of Broadcast), when there is no response from the storage battery module 110-2 or when an RSSI (Received Signal Strength Indicator) value is low, the managing device 120 determines that communication is impossible at the frequency width W1 and as shown in FIG. 22E (an arrow 22E in FIG. 22C), a spread amount is increased by changing a chip rate. This can avoid the falling by expanding the frequency band.

### Ninth Embodiment

As shown in FIG. 1, in the assembled battery system performing the wireless communication inside the metal housing 101 and having the metal door 102 and the handle 103 for opening and closing, the communication operation mode can be switched inside the assembled battery system by detecting the opening and closing of the door 102. For example, switching from the normal “periodically collecting mode” to “maintenance mode” is provided by detecting opening of the door 102.

In the “periodically collecting mode”, an alarm is generated by lighting an LED, etc. provided on the upper device or the metal housing 101 by detecting failure in communication generally a plurality of times. In the “maintenance mode” in which the door 102 is in an opening state, this alarm is not generated. Further, it is possible to transmit information indicating that the door 102 is open. Further, when the managing device 120 has a frequency change function described in the fourth embodiment, and opening of the door 102 is detected, it is possible to inhibit the frequency change. This allows that the communication frequency which has been learned in a closing state of the door 102 can be held.

In the present embodiment, when the metal housing 101 covering the assembled battery system is opened or closed due to exchanging the battery cell and maintenance, etc. it is prevented that a setting environment of the wireless communication is changed.

The present invention is not limited to the above-described embodiment, but includes other modifications and applications without departure from the spirit of the present claimed invention.

Further, the embodiments disclosed above have been described to be easily understood, and the invention is not limited to the configuration including all configurations described above. Further, it is possible to changeover a part of a configuration in an embodiment can be replaced with a part of other embodiment and it is also possible to add to a configuration of other embodiment. Further, it is possible to add to, delete and to replace a part of configurations of each of the embodiments.

Further, regarding each of configurations, the functions, processing parts, processing means, etc. may be realized with hardware by making a design for an integrated circuit. Further, as illustrated in FIGS. 1 and 5, the above-described configurations and functions, etc can be realized with software in which a processor interprets a program for providing these functions and executes the program. The information of the programs, tables, files, etc for providing each of the functions can be held in a recording device such as a memory, a hard disk drive, an SSD (Solid State Drive), etc. or a recording medium such as an IC (Integrated Circuit) card, an SD (Secure Digital) card, an optical disk, etc. Further, in the present specification, the processing steps describing time-base processes includes, in addition to the processes which are executed in a time base along a described order, processes executed in parallel or independently (for example, parallel processes or process by an object).

Further, only control lines and data lines which are thought to be necessary for explanation are illustrated, thus, not all control lines and data line are illustrated. Actually, almost all configurations are connected mutually.

### DESCRIPTION OF REFERENCE SYMBOLS

10, 10-1, 10-2 storage battery system
20 storage battery system controller
21, 101 metal housing
22 door
100, 100-1 to 100-n assembled battery system
110 storage battery module
111,121 small case
115 secondary battery
116 cell monitoring unit (battery monitoring unit)
117 controlling unit (storage battery module side managing device)
118 communicating unit
119, 123 antenna
120 managing device
122 managing unit

1. An assembled battery system comprising:
a storage battery module side managing device including:
a battery monitoring unit, to acquire battery information, monitoring a battery state of each of storage batteries belonging to a storage battery module including a plurality of the storage batteries connected in series, parallel, or serial-parallel; and
a communication unit performing wireless transmission of the battery information inside a metal case housing the storage battery modules; and
a managing device that manages the respective storage battery modules by performing wireless communication in the metal case at a constant interval each other with each of the storage battery module side managing devices equipped with each of the storage battery modules, wherein
the managing device transmits a measuring command including information specifying a next measuring timing to the respective storage battery module side managing devices to control in accordance with the measuring command the battery monitoring units to measure the battery states instantaneously between respective storage battery modules.

2. The assembled battery system as claimed in claim 1, wherein the managing device transmits the measuring command to the battery module side managing devices by broadcasting, and wherein
the storage battery module side managing device independently transmits the measured battery information to the managing device.

3. The assembled battery system as claimed in claim 1, wherein the managing device transmits the measuring command to the storage battery module side managing devices by broadcasting and the measuring command by unicast upon re-transmission.

4. The assembled battery system as claimed in claim 1, wherein when the managing device fails to receive a response from the storage battery module side managing device, the managing device re-transmits the measuring command, after changing a communication frequency.

5. The assembled battery system as claimed in claim 1, wherein when the managing device cannot to receive a response from the storage battery side managing device, the managing device selects a certain one of the storage battery module side managing devices as a relay device and causes the certain one of the storage battery module side managing devices to relay the measuring command and a response of the battery information.

6. The assembled battery system as claimed in claim 5, wherein
the managing device selects the certain one of the storage battery module side managing devices having a high SOC (State Of Charge) to cause the certain one of the storage battery module side managing devices to perform relaying.

7. The assembled battery system as claimed in claim 5, wherein when the managing device fails in communication after changing the frequency, or there is one allocated frequency, the managing device causes the storage battery module side managing device to perform relaying.

8. The assembled battery system as claimed in claim 1, wherein the managing device individually transmits the measuring command to each of the storage battery module side managing device, wherein the storage battery module side managing devices having received the measuring command simultaneously transmit the battery information to the managing devices.

9. The assembled battery system as claimed in claim 1, wherein the managing device includes:
acquiring means for acquiring a propagation state of electromagnetic waves in the assembled battery system, and
storing means for storing a pattern for changing a frequency for re-transmission, wherein
the managing device changes a frequency to one of previously allocated frequencies for one of the storage battery module side managing device of which propagation state of electromagnetic waves is deteriorated and transmits the measuring command to the corresponding storage battery module.

10. A storage battery system including a plurality of assembled battery systems, which are arranged, each of the assembled battery system being as claimed in claim 1, wherein
either of a communication time, a communication frequency, a communication space, and a spreading code is changed for each of the assembled battery systems.

11. A battery system including a plurality of assembled battery systems, which are arranged, each of the assembled battery system as claimed in claim 1, comprising:
a hierarchical structure including hierarchies of:
a plurality of the storage battery modules;
the assembled battery system in which a plurality of the storage battery modules are combined; and
a storage battery system in which a plurality of the assembled battery modules are combined, in this order; wherein
wireless communication in each of hierarchies is combined with any one of a multiple access control method of time division, a multiple access control method of frequency division, and a multiple access control method of spread code is combined.

12. A storage battery system including a plurality of assembled battery systems as claimed in claim 1, which are arranged, wherein wireless communication between the storage battery modules is made by time division multiple access control method, wireless communication between the assembled battery systems is made by frequency-division multiple access control method, or wireless transmission between the storage battery systems is made by spread code multiple access control method.

13. A method of monitoring and controlling an assembled battery system including:
a storage battery module side managing device including:
a battery monitoring unit, to acquire battery information, monitoring a battery state of each of storage batteries belonging to a storage battery module including a plurality of the storage batteries connected in series, parallel, or serial-parallel; and
a communicating unit performing wireless transmission of the battery information inside a metal case housing the storage battery modules; and
a managing device that manage the respective storage battery modules by performing wireless communication in the metal case at a constant interval each other with each of the storage battery module side managing devices equipped with each of the storage battery modules, the method comprising:
transmitting a measuring command including information specifying a next measuring timing to each of the storage battery module side managing devices by the managing device; and
controlling the battery monitoring units to measure the battery state of the storage batteries simultaneously between the storage battery modules.
